(19) United States
(12) Patent Application Publication
(10) Pub. No.: US 2015/0187343 A1
(43) Pub. Date: Jul. 2, 2015

(54) PEDAL DEVICE FOR MUSICAL INSTRUMENT

(71) Applicant: ROLAND CORPORATION, SHIZUOKA (JP)

(72) Inventor: YOSHIAKI MORI, SHIZUOKA (JP)

(21) Appl. No.: 14/565,422

(22) Filed: Dec. 10, 2014

(30) Foreign Application Priority Data
Dec. 27, 2013 (JP) 2013-271910

(51) Int. Cl. G10D 13/00

(52) U.S. Cl. CPC G10D 13/006

(57) ABSTRACT

A pedal device for a musical instrument is provided. The pedal device includes a pedal to be operated by a player and a biasing member generating a biasing force for restoring the pedal to an initial position. The pedal device further includes a rotating member that rotates around a rotation axis along with the operation of the pedal. A plurality of engaging parts are disposed in the rotating member. The engaging parts extend substantially in parallel to the rotation axis and are configured for engaging with a weight, and the engaging parts are respectively positioned at different distances with respect to the rotation axis.

### CROSS-REFERENCE TO RELATED APPLICATIONS

This application claims the priority benefit of Japan application serial no. 2013-271910, filed on Dec. 27, 2013. The entirety of the above-mentioned patent application is hereby incorporated by reference herein and made a part of this specification.

### BACKGROUND OF THE INVENTION

1. Field of the Invention

The present invention relates to a pedal device for a musical instrument. In particular, the present invention relates to a pedal device for a musical instrument, by which the operational feeling of stepping on a pedal is adjustable while the costs are kept low.

2. Description of Related Art

U.S. Pat. No. 4,691,612 and U.S. Pat. No. 5,998,718 disclose pedal devices that respectively include a pedal, a beater shaft, and a beater part. Here, the pedal is provided to be stepped by the player. The beater shaft is rotated in conjunction with the stepping on the pedal. The beater part is attached to a tip of the beater shaft. In addition, a struck head is struck by the beater part.

In these pedal devices, a weight that serves as a mass body is installed on the beater shaft. The weight can be moved along the beater shaft. Moreover, the weight can be fixed at any position by a fastening force provided by a screw. Thus, the distance between a rotation axis of the beater shaft and the mass body (weight) can be varied by changing the position where the weight is fixed. In other words, the operational feeling (inertial force) that the player feels when stepping on the pedal is adjustable.

However, in the pedal devices disclosed in U.S. Pat. No. 4,691,612 and U.S. Pat. No. 5,998,718, the beater shaft is perpendicular to the rotation axis. Therefore, a centrifugal force is applied on the weight when the beater shaft rotates. The centrifugal force is a directional force that moves the weight along the beater shaft. For this reason, the fastened screw that secures the weight on the beater shaft may become loose easily. If the secured weight goes loose during performance, the weight may move back and forth intensely along the beater shaft. As a result, the performance is hindered, and what is more, the pedal device may be damaged due to collision of the weight.

In contrast to the above, a non-patent literature (URL: http://www.mapexjapan.com/top/faicon.html) discloses a pedal device, in which a through hole is formed in the beater part for installing the weight. The operational feeling of stepping on the pedal is adjusted according to the weight of the weight installed in the through hole. In this pedal device, the through hole is formed in parallel to the rotation axis. Therefore, even though the weight is under the centrifugal force that accompanies the rotation of the beater shaft, the weight can be retained by the inner peripheral surface of the through hole. As a result, the weight can remain secured.

Regarding the pedal device disclosed in the non-patent literature, the operational feeling the player feels when stepping on the pedal is adjusted by changing the weight of the installed weight. Thus, it is necessary to prepare several weights having different weights in order to adjust the operational feeling at will. It results in the problem of higher costs.

### SUMMARY OF THE INVENTION

In view of the above, the present invention provides a pedal device for a musical instrument, by which the operational feeling of stepping on the pedal is adjustable while the costs are kept low.

According to the technical proposal 1, a pedal device for a musical instrument includes a pedal to be operated by a player, a biasing member that generates a biasing force for restoring the pedal to an initial position, and a rotating member that is rotated around a rotation axis along with the operation of the pedal, wherein a plurality of engaging parts, which extend substantially in parallel to the rotation axis for engaging with a weight, are disposed in the rotating member and are respectively positioned at different distances with respect to the rotation axis. Therefore, the engaging parts for engaging with the weight extend substantially in parallel to the rotation axis. Thus, when the weight is under the centrifugal force that accompanies the rotation of the rotating member, the engagement of the weight and the engaging part can be maintained stable.

In this case, the engaging parts are respectively positioned at different distances with respect to the rotation axis. Thus, by changing the installation position (the engaging part) of the weight, the distance between the rotation axis and the weight can be varied. Thereby, the operational feeling (inertial force) the player feels when stepping on the pedal can be adjusted. In other words, it is sufficient to prepare at least one weight. Accordingly, the operational feeling of stepping on the pedal can be adjusted while the costs are kept low.

Furthermore, according to the technical proposal 1, if more than one weight is prepared, the installation positions of the weights and the number of the weights that are installed can be combined. As a result, the operational feeling of stepping on the pedal can be selected more flexibly. In that case, the weights may have the same structure. Accordingly, increase of the costs can be avoided.

According to the technical proposal 2, in the pedal device, at least a portion of the engaging parts are disposed in positions overlapping a striking part in a front view or disposed between the striking part and the rotation axis in the front view. Thus, in addition to the effects of the pedal device of the technical proposal 1, the engaging parts can be disposed at least near the striking part or on a side closer to the rotation axis than the striking part. Therefore, in comparison with the case where the weight is installed on a side far away from the rotation axis with the striking part positioned between the weight and the rotation axis, for example, the vibration of the rotating member that occurs after a struck object (e.g. a struck part) is struck by the striking part can be suppressed. As a result, when the present invention is applied to an electronic musical instrument, for example, erroneous detection of the sensor can be reduced.

According to the technical proposal 3, in the pedal device, the engaging parts are through holes that penetrate through the rotating member in parallel to the rotation axis. Thus, an outer peripheral surface of the weight can be surrounded by an inner peripheral surface of the engaging part (through hole). In other words, even if the weight is under the centrifugal force that accompanies the rotation of the rotating member, the weight can be retained by the inner peripheral surface of the through hole. Accordingly, in addition to the effects of the pedal device of the technical proposal 1 or 2, the fixing of the weight can be maintained effectively.

Moreover, in the technical proposal 3, the cross-sectional shape of the engaging part can be set at will. For example, the cross-sectional shape of the engaging part may be circular, oval, or polygonal.

According to the technical proposal 4, in the pedal device, the engaging part is a through hole having a circular cross section. In addition, the weight has a cylindrical shape that has an outer diameter corresponding to an inner diameter of the engaging part. Thus, in addition to the effects of the pedal device of the technical proposal 3, the engaging part and the weight can be manufactured easily. In other words, the costs can be reduced. Moreover, even if the weight is under the centrifugal force that accompanies the rotation of the rotating member, the outer peripheral surface of the weight can be easily retained by the inner peripheral surface of the through hole. Hence, the fixing of the weight can be maintained easily.

The aforementioned “an outer diameter corresponding to an inner diameter of the engaging part” has the following meaning, for example. If the engaging part is formed in the rotating member that is made of a metal material, a non-ferrous material such as aluminum alloy, or a resin material, the inner diameter of the engaging part and the outer diameter of the weight are equal, or the outer diameter of the weight is slightly smaller than the inner diameter of the engaging part. On the other hand, if the engaging part is formed in an elastic base body made of a rubbery elastic material, the inner diameter of the engaging part and the outer diameter of the weight are equal, or the outer diameter of the weight is slightly larger than the inner diameter of the engaging part.

According to the technical proposal 5, the pedal device includes the weight that is inserted into the engaging part. In addition, the rotating member includes an insertion hole. The insertion hole penetrates through a portion of the rotating member between an outer surface of the rotating member and the engaging part. Further, a male screw is inserted into the insertion hole for fixing the weight. The weight includes a retaining hole that is recessed on or penetrates through the weight for screwing or inserting the male screw inserted in the insertion hole. Thus, in addition to the effects of the pedal device of the technical proposal 3 or 4, the weight can be firmly fixed in the engaging part by inserting the male screw into the insertion hole from the outer surface of the rotating member and screwing or inserting the inserted male screw into the retaining hole of the weight.

According to the technical proposal 6, the pedal device includes the weight that is inserted into the engaging part and a screw member for fixing the weight in the engaging part. In addition, the rotating member includes an insertion hole that penetrates through a portion of the rotating member between the outer surface of the rotating member and the engaging part, and the screw member is inserted into the insertion hole. Further, the weight includes a fastening hole that penetrates through the weight in a direction perpendicular to a longitudinal direction of the weight, and a female thread is formed on an inner peripheral surface of the fastening hole for screwing the screw member. Thus, the screw member can be inserted into the insertion hole from the outer surface of the rotating member, and the inserted screw member can be screwed into the fastening hole of the weight to cause a tip of the screw member to protrude out of the fastening hole of the weight to be in contact with the inner peripheral surface of the engaging part. Thus, in addition to the effects of the pedal device of the technical proposal 3 or 4, the outer peripheral surface of the weight on the side opposite to the outer peripheral surface where the screw member protrudes is pressed against the inner peripheral surface of the engaging part to fix the weight in the engaging part.

In this case, when the tip of the screw member screwed into the fastening hole of the weight is in contact with the inner peripheral surface of the engaging part of the rotating member, a head part of the screw member is positioned in the insertion hole of the rotating member. Thus, even if the fastened screw member is loose, the rear end (the head part) of the screw member is locked to the inner peripheral surface of the insertion hole and can effectively prevent the weight from coming out of the engaging part.

According to the technical proposal 7, when the pedal of the pedal device is stepped by the player, the stepping motion is transmitted to the rotating member through the connecting member. Moreover, while the rotating member is rotated around the rotation axis, the struck part is struck by the striking part. Thus, in addition to the effects of the pedal device of any one of the technical proposals 1 to 6, the player can feel the operational feeling (inertial force) through the rotation of the rotating member. When the present invention is applied to an electronic musical instrument, for example, the player can get a feeling that resembles the operational feeling of playing an acoustic bass drum.

According to the technical proposal 8, by supporting the rotating member rotatably and pivotally around the rotation axis on the base, the rotating member also serves as the pedal. Thus, in addition to the effects of the pedal device of any one of the technical proposals 1 to 6, the number of the parts can be reduced and the structure can be simplified. As a result, the costs can be reduced.

According to the technical proposal 9, the pedal device includes a sensor configured to detect an operational state of the pedal. Thus, in addition to the effects of the pedal device of any one of the technical proposals 1 to 8, the pedal device can be used as an electronic musical instrument.

The sensor configured to detect the operational state of the pedal may be a sensor that detects the striking (e.g. pressure or acceleration) of the striking part on the struck part, for example. In addition, the sensor may detect a rotation state (angle, angular speed, angular acceleration, etc.) of the pedal, for example.

According to the technical proposal 10, a pedal device for a musical instrument includes a pedal to be operated by a player, a biasing member that generates a biasing force for restoring the pedal to an initial position, and a base that is placed on the floor and rotatably and pivotally supports one side of the pedal, wherein a plurality of engaging parts, which extend substantially in parallel to a rotation axis for engaging with a weight, are disposed in the pedal and are respectively positioned at different distances with respect to the rotation axis.

### BRIEF DESCRIPTION OF THE DRAWINGS

FIG. 1 is a perspective view of a pedal device according to the first embodiment of the present invention.

FIG. 2A is a top view of the pedal device.

FIG. 2B is a cross-sectional view of the pedal device taken along the line IIb-IIb of FIG. 2A.

FIG. 3 is a rear perspective view of a rotating member.

FIG. 4A is a front view of the rotating member.

FIG. 4B is a side view of the rotating member when viewed in the direction of the arrow IVb of FIG. 4A.

FIG. 4C is a rear view of the rotating member when viewed in the direction of the arrow IVc of FIG. 4B.

FIG. 5A is a partially enlarged front view of the rotating member.

FIG. 5B is a partially enlarged cross-sectional view of the rotating member taken along the line Vb-Vb of FIG. 5A.

FIG. 6A is a partially enlarged front view of a rotating member according to the second embodiment.

FIG. 6B is a partially enlarged cross-sectional view of the rotating member taken along the line VIb-VIb of FIG. 6A.

FIG. 7A is a partially enlarged front view of a rotating member according to the third embodiment.

FIG. 7B is a partially enlarged cross-sectional view of the rotating member taken along the line VIIb-VIIb of FIG. 7A.

FIG. 8A is a partially enlarged front view of a rotating member according to the fourth embodiment.

FIG. 8B is a partially enlarged cross-sectional view of the rotating member taken along the line VIIIb-VIIIb of FIG. 8A.

FIG. 8C is a partially enlarged cross-sectional view of the rotating member taken along the line VIIIc-VIIIc of FIG. 8A.

FIG. 9A is a partially enlarged front view of a rotating member according to the fifth embodiment.

FIG. 9B is a partially enlarged cross-sectional view of the rotating member taken along the line IXb-IXb of FIG. 9A.

FIG. 9C is a partially enlarged cross-sectional view of the rotating member taken along the line IXc-IXc of FIG. 9A.

FIG. 10A is a partially enlarged front view of a rotating member according to the sixth embodiment.

FIG. 10B is a partially enlarged cross-sectional view of the rotating member taken along the line Xb-Xb of FIG. 10A.

FIG. 10C is a partially enlarged cross-sectional view of the rotating member taken along the line Xc-Xc of FIG. 10A.

FIG. 11A is a rear view of a rotating member according to the seventh embodiment.

FIG. 11B is a cross-sectional view of the rotating member taken along the line XIb-XIb of FIG. 11A.

FIG. 12A is a front view of a main body part.

FIG. 12B is a cross-sectional view of the main body part taken along the line XIIb-XIIb of FIG. 12A.

FIG. 13A is a partially enlarged front view of a rotating member according to the eighth embodiment.

FIG. 13B is a partially enlarged cross-sectional view of the rotating member taken along the line XIIIb-XIIIb of FIG. 13A.

FIG. 14A is a partially enlarged front view of a rotating member according to the ninth embodiment.

FIG. 14B is a partially enlarged cross-sectional view of the rotating member taken along the line XIVb-XIVb of FIG. 14A.

FIG. 15A is a top view of a pedal device according to the tenth embodiment.

FIG. 15B is a cross-sectional view of the pedal device taken along the line XVb-XVb of FIG. 15A.

### DESCRIPTION OF THE EMBODIMENTS

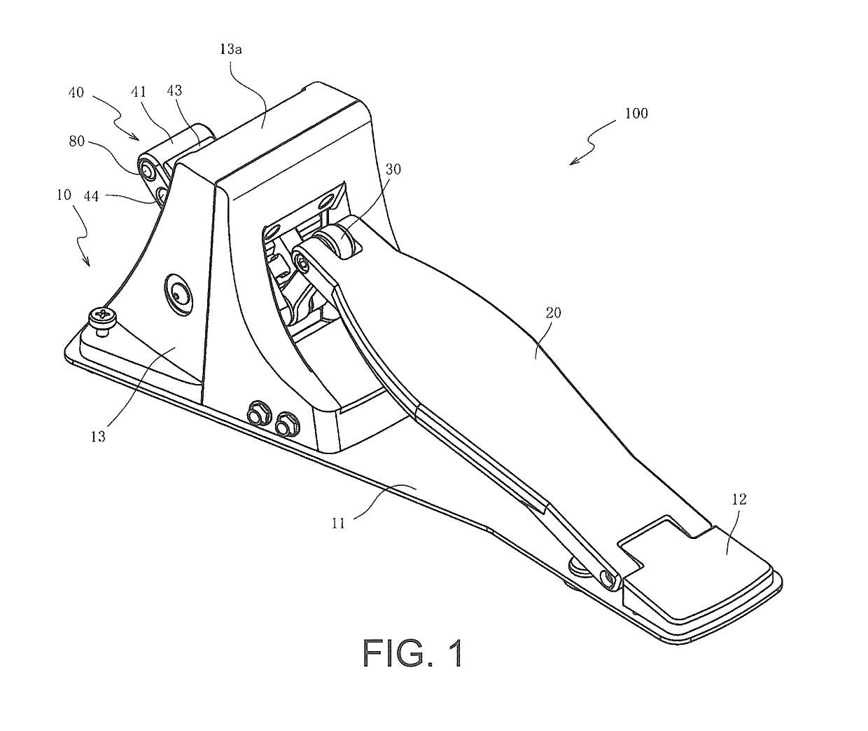

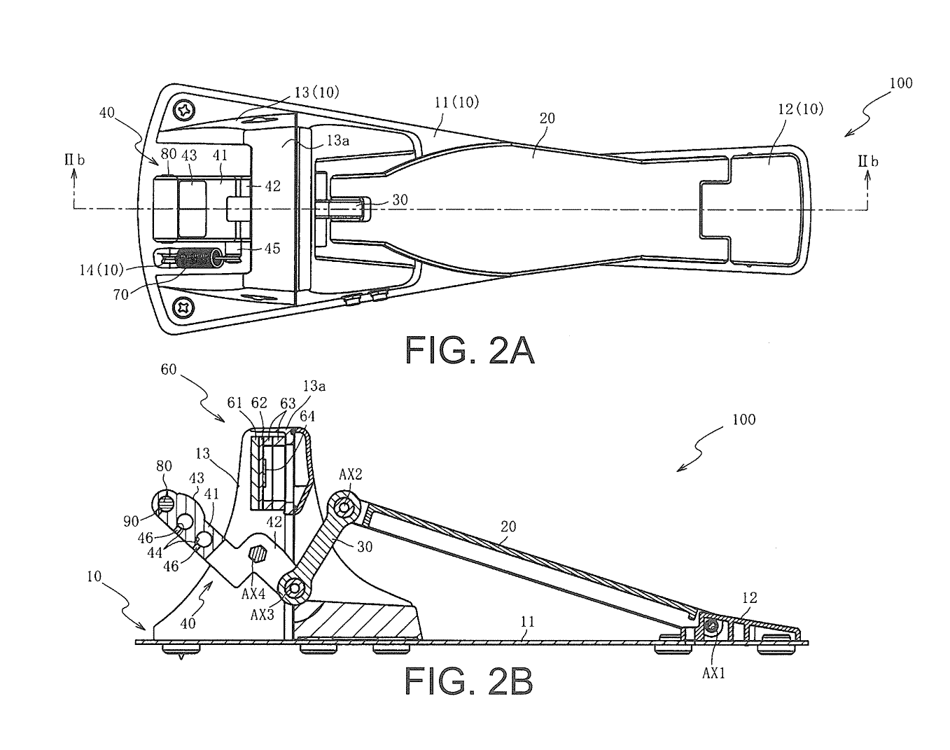

Below exemplary embodiments of the present invention are described in detail with reference to the affixed figures. First, a pedal device 100 of the first embodiment of the present invention is described hereinafter with reference to FIG. 1 to FIG. 5B. FIG. 1 is a perspective view of the pedal device 100 in the first embodiment of the present invention. FIG. 2A is a top view of the pedal device 100. FIG. 2B is a cross-sectional view of the pedal device 100 taken along the line IIb-IIb of FIG. 2A.

As shown in FIG. 1, FIG. 2A, and FIG. 2B, the pedal device 100 mainly includes a base 10, a pedal 20, a connecting member 30, a rotating member 40, a struck member 60, and a biasing member 70. The base 10 is placed on the floor. The pedal 20 is pivotally supported by the base 10 in a rotatable manner. The connecting member 30 is rotatably and pivotally supported by the pedal 20 at one end side. The rotating member 40 is rotatably and pivotally supported by the other end side of the connecting member 30. The rotating member 40 is rotated due to the stepping on the pedal 20. The struck member 60 is positioned on a rotation track of the other end side (a striking part 43) of the rotating member 40. The biasing member 70 generates a biasing force for restoring the stepped pedal 20 to an initial position.

The base 10 is a part that serves as the foundation of the pedal device 100. The base 10 includes a ground plate 11, a pedal pivotal support part 12, a pair of upright parts 13, and a spring connecting part 14. The ground plate 11 has a long plate shape and is placed on the floor (grounded). The pedal pivotal support part 12 is disposed at one side of the ground plate 11 in a longitudinal direction. The upright parts 13 are disposed to stand upright and face each other at the other side of the ground plate 11 in the longitudinal direction. The spring connecting part 14 is formed on the ground plate 11, and an end portion of the biasing member 70 is connected with the spring connecting part 14. A bridging part 13a is disposed on the upright parts 13 to bridge between the opposing upright tip sides of the upright parts 13. With this configuration, the struck member 60 can be disposed in the upright parts 13, as described hereinafter. Furthermore, the rigidity for rotatably and pivotally supporting the rotating member 40 and the rigidity for supporting the struck member 60 when the struck member 60 is struck can be ensured.

The pedal 20 is an operation unit having a long plate shape to be stepped and operated by the player. The pedal 20 is disposed in a manner that a longitudinal direction of the pedal 20 is consistent with the longitudinal direction of the ground plate 11 of the base 10. In addition, one end side of the pedal 20 in the longitudinal direction is rotatably and pivotally supported by the pedal pivotal support part 12 of the base 10 through a first axis AX1. The first axis AX1 is formed in parallel to a second axis AX2, a third axis AX3, and a fourth axis AX4, which will be described later.

The connecting member 30 is a member provided for rotatably connecting the pedal 20 and the rotating member 40. One end side of the connecting member 30 in the longitudinal direction is rotatably and pivotally supported by the other end side of the pedal 20 in the longitudinal direction through the second axis AX2. Moreover, the other end side of the connecting member 30 in the longitudinal direction is rotatably and pivotally supported by one end side of the rotating member 40 in the longitudinal direction through the third axis AX3.

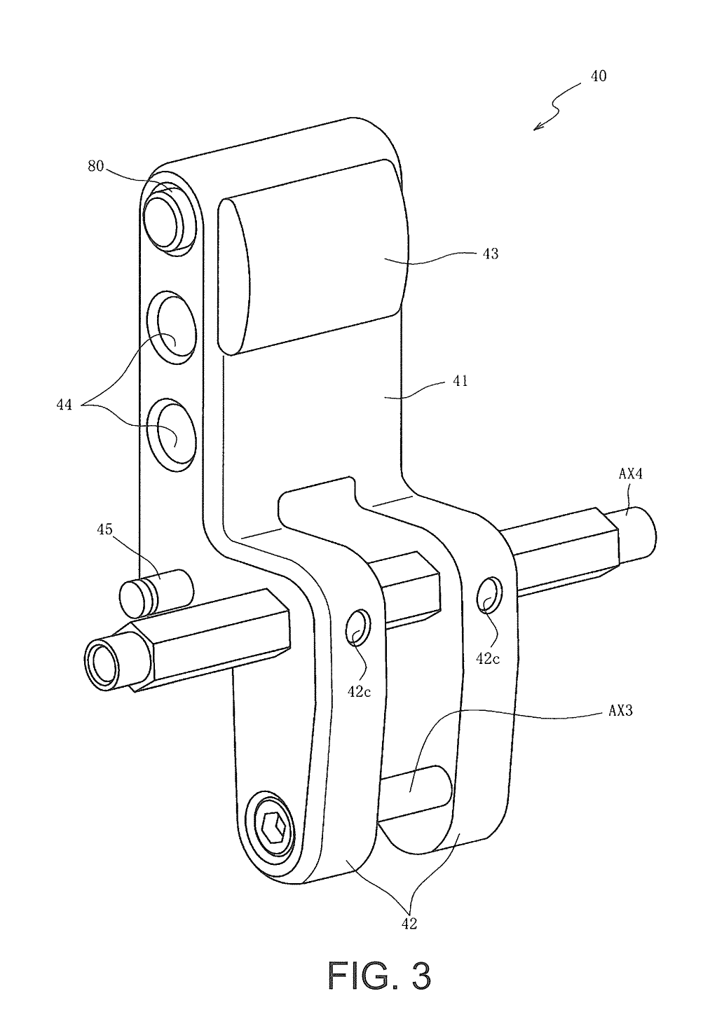

The rotating member 40 is a member that rotates in conjunction with the player's stepping operation on the pedal 20. The rotating member 40 is rotatably and pivotally supported between the upright parts 13 of the base 10 through the fourth axis AX4. A plurality of engaging parts 44, configured for installing a weight 80, are formed in the rotating member 40. The engaging parts 44 are respectively positioned at different distances from the fourth axis AX4. By selecting an appropriate position (engaging part 44) among the engaging parts 44 to install the weight 80, the operational feeling (inertial force) of stepping on the pedal 20 can be adjusted. A structure of the rotating member 40 will be described later with reference to FIG. 3 to FIG. 5B.

The struck member 60 is a member provided to be struck by the striking part 43 of the rotating member 40. The struck member 60 is positioned on the rotation track of the striking part 43 when the rotating member 40 rotates around an axial center of the fourth axis AX4. In addition, the struck member 60 is disposed above the fourth axis AX4 in a vertical direction. The struck member 60 mainly includes an elastic member 61, a struck support plate 62, an interposing member 63, and a sensor 64. The elastic member 61 is in a position facing the striking part 43 of the rotating member 40. The struck support plate 62 is disposed on a back surface of the elastic member 61. The interposing member 63 is disposed between the struck support plate 62 and the bridging part 13a of the upright parts 13. The sensor 64 is disposed on a back surface of the struck support plate 62.

The elastic member 61 is a member provided to be struck by the striking part 43. The elastic member 61 is made of a rubbery elastic material and has a rectangular plate shape in the front view. The struck support plate 62 is made of a metal material. In addition, the struck support plate 62 has a rectangular plate shape in the front view, which is the same as the shape of the elastic member 61. The struck support plate 62 supports the entire back surface of the elastic member 61. The interposing member 63 is made of an elastic material and has a rectangular frame shape in the front view. The interposing member 63 surrounds the periphery of the sensor 64 and connects the struck support plate 62 with the bridging part 13a of the base 10.

The sensor 64 is a piezoelectric sensor configured to detect vibration of the struck support plate 62. The sensor 64 is electrically connected with a sound source device (not shown). When the struck member 60 is struck by the striking part 43, the struck support plate 62 vibrates. The vibration of the struck support plate 62 is detected by the sensor 64. In addition, a detection signal as detected is outputted to the sound source device. With this configuration, a musical sound conforming to the player's preference can be generated from the sound source device according to the detected detection signal. Thus, by disposing the sensor 64 in the struck member 60, the pedal device 100 can be used as an electronic percussion instrument.

According to this embodiment, the struck support plate 62 is supported by the interposing member 63 that is made of an elastic material. Therefore, the vibration of the struck support plate 62 caused by the striking of the striking part 43 can be damped (reduced) easily. Transmission of the vibration of the floor or the pedal 20 to the struck support plate 62 can be suppressed as well. As a result, erroneous detection of the sensor 64 can be reduced.

The biasing member 70 is a member provided for applying a biasing force to the rotating member 40. The biasing member 70 is formed with a tension spring (coil spring). An end of the biasing member 70 is connected with the spring connecting part 14 of the base 10 in a state that the biasing member 70 is pulled and elastically deforms. Further, the other end of the biasing member 70 is connected with a spring connecting pin 45 of the rotating member 40. Because of the elastic resilience of the biasing member 70, the rotating member 40 is biased in a direction away from the struck member 60. Here, the “direction away from the struck member 60” refers to a direction in which the rotating member 40 rotates counterclockwise around the fourth axis AX4 in FIG. 2B. Thus, in a state that the pedal 20 is not stepped, the pedal 20 is maintained at the initial position as shown in FIG. 1, FIG. 2A, and FIG. 2B. In addition, when the stepped pedal 20 is released, the pedal 20 returns to the initial position.

With the pedal device 100 that has the above configuration, when the player steps on the pedal 20, the second axis AX2 is pressed downward. In addition, the third axis AX3 is pushed by the connecting member 30 in a direction to enter a space under the fourth axis AX4. Accordingly, the rotating member 40 is rotated clockwise (right-handed rotation) around the fourth axis AX4 in FIG. 2B. When the pedal 20 is stepped to a predetermined degree, the elastic member 61 of the struck member 60 is struck by the striking part 43 of the rotating member 40.

That is, according to this embodiment, the pedal device 100 is configured such that the side of the striking part 43 of the rotating member 40 (the side opposite to the third axis AX3 with respect to the fourth axis AX4) is lifted up when the pedal 20 is stepped. Therefore, the player who steps on the pedal 20 can feel the weight. In other words, the player can get a feeling that resembles the operational feeling of playing an acoustic bass drum.

In this case, as described above, the installation position of the weight 80 in the rotating member 40 is changeable. That is to say, the operational feeling (inertial force) the player feels when stepping on the pedal 20 can be adjusted according to the installation position of the weight 80. Therefore, the player can adjust the weight according to the player's preference. The structure of the rotating member 40 is explained in detail hereinafter with reference to FIG. 3 to FIG. 5B.

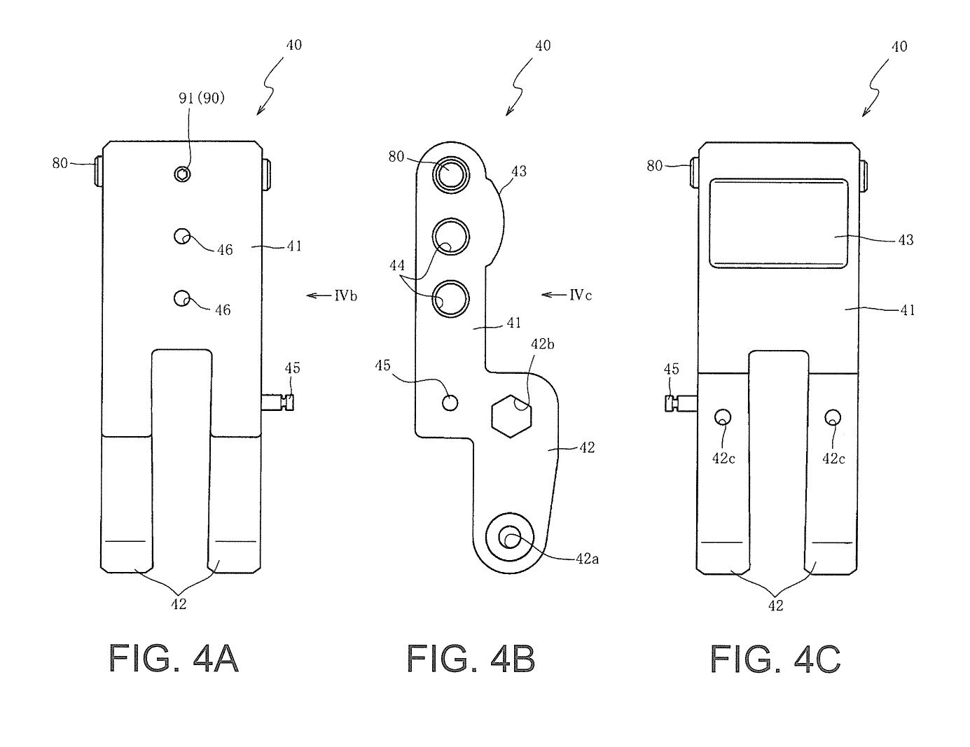

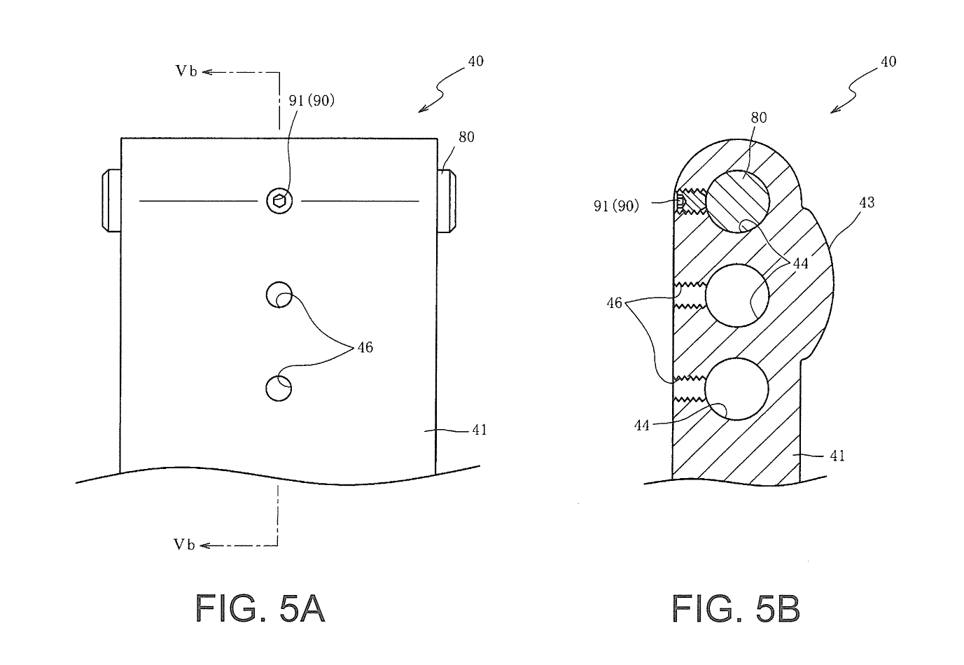

FIG. 3 is a rear perspective view of the rotating member 40. FIG. 4A is a front view of the rotating member 40. FIG. 4B is a side view of the rotating member 40 when viewed in the direction of the arrow IVb of FIG. 4A. FIG. 4C is a rear view of the rotating member 40 when viewed in the direction of the arrow IVc of FIG. 4B. Further, FIG. 5A is a partially enlarged front view of the rotating member 40. FIG. 5B is a partially enlarged cross-sectional view of the rotating member 40 taken along the line Vb-Vb of FIG. 5A.

FIG. 3 to FIG. 5B illustrate a state where the weight 80 is installed in the upper engaging part 44, and the weight 80 is fastened and secured by a set screw 90. FIG. 3 further illustrates a state where the third axis AX3 and the fourth axis AX4 are installed in the rotating member 40.

As shown in FIG. 3 to FIG. 5B, the rotating member 40 mainly includes a main body part 41, connecting legs 42, the striking part 43, the engaging parts 44, the spring connecting pin 45, and a fastening hole 46. The connecting legs 42 respectively extend from a side of the main body part 41. The striking part 43 protrudes from a back surface of the main body part 41. The engaging parts 44 pass through the main body part 41. The spring connecting pin 45 protrudes from a side surface of the connecting leg 42. The fastening hole 46 is opened on a front surface of the main body part 41.

The main body part 41, the connecting legs 42, and the striking part 43 are formed integrally by aluminum die-casting or zinc die-casting. The main body part 41 has a predetermined thickness and has a flat plate shape that is rectangular and vertically long in the front view. The connecting leg 42 has a crank shape (a shape formed by connecting right-angled L shapes) when viewed from a side. Moreover, the connecting legs 42 are spaced by a predetermined interval in a width direction of the main body part 41 and are respectively connected with an end of the main body part 41 in the longitudinal direction. The striking part 43 has a semicylindrical shape that bends and protrudes to form an arc-shaped cross section. Here, the semicylindrical shape refers to a shape that protrudes from the back surface of the main body part 41 and has a cross section curved in an arc shape at least at a top portion on a plane perpendicular to the fourth axis AX4.

Insertion holes 42a and 42b are formed in the connecting legs 42 for inserting the third axis AX3 and the fourth axis AX4. The insertion hole 42a is a through hole with a circular cross section, which passes through the other ends of the connecting legs 42. The third axis AX3 is inserted into the insertion hole 42a. The insertion hole 42b is a through hole with a hexagonal cross section, which passes through bent portions of the connecting legs 42. The fourth axis AX4 is inserted into the insertion hole 42b. A cylindrical portion of the third axis AX3 exposed between the opposing connecting legs 42 is pivotally supported by the connecting member 30. Cylindrical portions at two ends of the fourth axis AX4 are pivotally supported by the upright parts 13 of the base 10.

Recesses are respectively formed on two ends of the insertion hole 42a for receiving a head part of a shaft-shaped member that constitutes the third axis AX3 and a nut screwed to a male thread portion of a tip of the shaft-shaped member. In addition, a portion of the fourth axis AX4, which has the hexagonal cross section, is non-rotatably inserted in the insertion hole 42b. The fourth axis AX4 is fastened and fixed by a set screw (not shown) that is screwed into a fastening hole 42c. The fastening hole 42c penetrates through the connecting leg 42 from an outer surface (back surface) of the connecting leg 42 to the insertion hole 42b. Furthermore, a female thread is formed on an inner peripheral surface of the fastening hole 42c.

The engaging parts 44 are portions to be engaged with the weight 80. The engaging parts 44 are through holes formed in multiple positions of the main body part 41. The through hole has a circular cross section and passes through the main body part 41 in the width direction. In this embodiment, the engaging parts 44 are formed in three positions, i.e. an upper section, a middle section, and a lower section of the main body part 41. The engaging parts 44 are cylindrical holes with a constant inner diameter. Moreover, the engaging parts 44 respectively extend in parallel to the third axis AX3 and the fourth axis AX4. In addition, the engaging parts 44 are equally spaced from each other.

In this embodiment, the engaging parts 44 are equally spaced. Therefore, portions having lower rigidity due to the formation of the engaging parts 44 are not biased to a certain part of the rotating member 40 (the main body part 41), and the rigidity can be uniformized throughout the rotating member 40 (the main body part 41). Consequently, the durability of the rotating member 40 (the main body part 41) can be improved. In particular, the main body part 41 is a member provided for repeatedly striking the struck member 60 with the striking part 43. Thus, if a part of the main body part 41 has a weak portion, the portion may result in damage. For this reason, it is effective to space the engaging parts 44 equally.

As described above, the engaging parts 44 extend in parallel to the fourth axis AX4. Therefore, when the weight 80 is under the centrifugal force that accompanies the rotation of the rotating member 40, the weight 80 can be retained by the large-area inner peripheral surface of the engaging part 44. As a result, the engagement between the weight 80 and the engaging part 44 can be maintained stable.

Further, the engaging parts 44 respectively extend in parallel to the third axis AX3 (i.e. the insertion hole 42b). Thus, the processing of the engaging parts 44 and the insertion hole 42b can be carried out in the same process. That is, in a state that the rotating member 40, formed by aluminum die-casting, has been removed from a mold, the engaging part 44 is formed with a gradient for removing the mold. Therefore, it is necessary to perform a drilling process on the engaging part 44 such that the inner diameter of the engaging part 44 is constant in an axial direction. The insertion hole 42b is also formed through the connecting legs 42 by a drilling process. Thus, if the engaging parts 44 and the insertion hole 42b are parallel to each other, the drilling processes thereof can be carried out in the same process. In other words, the production efficiency can be improved.

In this embodiment, the hole formed by drilling the side surface of the connecting leg 42 in order to knock in the spring connecting pin 45 and the recess formed in the insertion hole 42b are also parallel. Thus, the drilling process thereof and the processing of the recess can also be carried out in the same drilling process described above.

In this case, among the engaging parts 44, the upper engaging part 44 (which is the farthest engaging part from the fourth axis AX4) is formed in a position that at least a portion of the upper engaging part 44 overlaps a formation area of the striking part 43 in the front view. That is to say, the upper and middle engaging parts 44 can be disposed near the striking part 43, and the lower engaging part 44 can be disposed on the side closer to the fourth axis AX4 than the striking part 43. Therefore, in comparison with the case where the weight 80 is installed on the side far away from the fourth axis AX4 with the striking part 43 positioned between the weight 80 and the fourth axis AX4 (i.e. the weight 80 is installed on the tip side of the rotating member 40 beyond the striking part 43), for example, the vibration of the rotating member 40 that occurs after the struck member 60 is struck by the striking part 43 can be suppressed. As a result, erroneous detection of the sensor 64 can be reduced.

As described above, the engaging part 44 is a cylindrical hole having a constant inner diameter. However, a chamfering process is performed respectively on opening portions of both ends. In other words, conical chamfered portions are respectively formed with an inner diameter that gradually increases outward and are formed at the opening portions of both ends of the engaging part 44. Accordingly, the weight 80 can be easily inserted into the engaging part 44 along the chamfered portion. Additionally, in the state that the pedal 20 is at the initial position, the engaging parts 44 are formed in an area not overlapping the upright parts 13 when viewed in the axial direction of the engaging parts 44 (refer to FIG. 2B). Thus, the weight 80 can be attached to or detached from the engaging part 44 without interfering with the upright parts 13.

The spring connecting pin 45 is a cylindrical member connected with the other end of the biasing member 70 (refer to FIG. 2A). An annular groove is recessed on a tip side of the spring connecting pin 45 for engagement with the other end of the biasing member 70. Further, a base side of the spring connecting pin 45 is knocked and fixed in the hole that is formed on the side surface of the connecting leg 42.

The fastening hole 46 is a hole that penetrates through a portion of the main body part 41 between the front surface of the main body part 41 (the outer surface of the rotating member 40) and the engaging part 44. A female thread is formed on the inner peripheral surface of the fastening hole 46. Thus, by screwing the set screw 90 (which will be described later) into the fastening hole 46, the weight 80 can be fastened and secured in the engaging part 44. The fastening hole 46 is disposed at a position that an extension line of an axial center of the fastening hole 46 is perpendicular to an axial center of the engaging part 44.

The weight 80 is a member that serves as a mass body. The weight 80 is made of a metal material and has a cylindrical shape having a circular cross section. The outer diameter of the weight 80 is equal to or slightly smaller than the inner diameter of the engaging part 44. Therefore, even if the weight 80 is under the centrifugal force that accompanies the rotation of the rotating member 40, the outer peripheral surface of the weight 80 can be easily retained by the inner peripheral surface of the engaging part 44. In other words, the fixing of the weight 80 can be maintained easily. In this embodiment, the weight 80 is made of a steel material; however, other materials may also be used. The other materials may include a nonferrous metal, e.g. brass, or a resin material, for example.

The length (full length) of the weight 80 in the axial direction is larger than the width (the length in the left-right direction of FIG. 4A) of the main body part 41. Therefore, end portions of the weight 80 respectively protrude from the side surfaces of the main body part 41. With this configuration, the protruding portion can be pushed into the engaging part 44 for grasping and pulling out the end portion that is pushed out from the other side. Moreover, a chamfering process is performed on both ends of the weight 80 to form chamfered portions that are tapered. Accordingly, the weight 80 can be easily inserted into the engaging part 44 using the chamfered portions. As a result, workability of attaching the weight 80 to or detaching the weight 80 from the engaging part 44 can be improved.

The set screw 90 is a screw that presses a tip thereof against the outer peripheral surface of the weight 80, so as to stop the movement of the weight 80 and fix the weight 80 in the engaging part 44. The set screw 90 is a full thread screw that has a hexagonal hole 91 on an end surface in the axial direction. The weight 80 is inserted into the engaging part 44, and the set screw 90 is screwed into the fastening hole 46 to press the outer peripheral surface of the weight 80 with the tip of the set screw 90. As a result, the outer peripheral surface opposite to the outer peripheral surface pressed by the tip of the set screw 90 is pressed against the inner peripheral surface of the engaging part 44 to fix the weight 80 in the engaging part 44.

As described above, in this embodiment, the main body part 41 includes the engaging part 44, which is a through hole, and the fastening hole 46 communicating with the engaging part 44. Here, the weight 80 is inserted into the engaging part 44 and secured by the set screw 90 screwed into the fastening hole 46. Therefore, it is not necessary to determine a circumferential position of the weight 80 with respect to the engaging part 44. The process of installing (inserting) the weight 80 into the engaging part 44 is simplified. In addition, it is not necessary to set the directionality of the weight 80 in the circumferential direction. Consequently, the weight 80 can be manufactured easily and the costs can be reduced.

The shape of the tip of the set screw 90 is a flat surface, so as to avoid damaging the weight 80. Therefore, the weight 80 can be used repeatedly.

According to the pedal device 100 with the aforementioned structure, a plurality of engaging parts 44 are positioned at different distances from the fourth axis AX4 respectively. Thus, by changing the position (the engaging part 44) where the weight 80 is installed, the distance between the fourth axis AX4 and the weight 80 can be varied. As a result, the operational feeling (inertial force) the player feels when stepping on the pedal 20 can be adjusted.

For example, by installing the weight 80 to the upper engaging part 44 as shown in FIG. 3, the distance between the weight 80 and the fourth axis AX4 is maximized and the operational feeling can be adjusted to be heavier. On the other hand, by installing the weight 80 to the lower engaging part 44, the distance between the weight 80 and the fourth axis AX4 is minimized and the operational feeling can be adjusted to be lighter. Further, by installing the weight 80 to the middle engaging part 44, the operational feeling can be adjusted to an intermediate level between the cases of the upper and the lower engaging parts 44.

According to the above, the adjustment of the operational feeling of stepping on the pedal 20 only requires preparation of at least one weight 80. It is not necessary to prepare several types of weights having different weights like the conventional devices. In other words, the operational feeling of stepping on the pedal 20 can be adjusted while the costs are kept low.

Further to the above, if multiple weights 80 are prepared for the pedal device 100, the upper, middle, and lower engaging parts 44 to which the weights 80 are installed and the number of the weights 80 that are installed can be combined. By doing so, the operational feeling of stepping on the pedal can be selected more flexibly. In that case, the multiple weights 80 may still have the same structure. In other words, since it is not necessary to prepare weights having different weights, increase of the costs can be avoided.

To be more specific, by preparing three weights 80, it is possible to select a combination of installing one weight 80 to one of the upper, middle, and lower engaging parts 44. In addition, it is possible to select a combination of installing two weights 80 respectively to the upper and the middle, the middle and the lower, or the upper and the lower engaging parts 44. Furthermore, it is possible to select a combination of installing three weights 80 to all the upper, middle, and lower engaging parts 44 respectively. In other words, the player can select at will from seven combinations. In this case, the three weights 80 may have the same structure. Therefore, increase of the costs can be avoided. In particular, in this embodiment, the weight 80 has a cylindrical shape that has a circular cross section. Thus, the shape of the weight 80 is simplified and can be manufactured easily. As a result, the costs can be reduced.

In addition, the engaging part 44 is a through hole having a circular cross section. The weight 80 has a cylindrical shape that has a circular cross section, and has the outer diameter corresponding to the inner diameter of the engaging part 44. Thus, the engaging parts 44 and the weight 80 can be easily manufactured and the costs can be reduced. Because the weight 80 has no directionality in the circumferential direction, the process of installing (inserting) the weight 80 into the engaging part 44 is simplified. Moreover, even if the weight 80 is under the centrifugal force that accompanies the rotation of the rotating member 40, the entire outer peripheral surface of the weight 80 can be in contact with the inner peripheral surface of the engaging part 44. Thereby, the fixing of the weight 80 can be maintained easily.

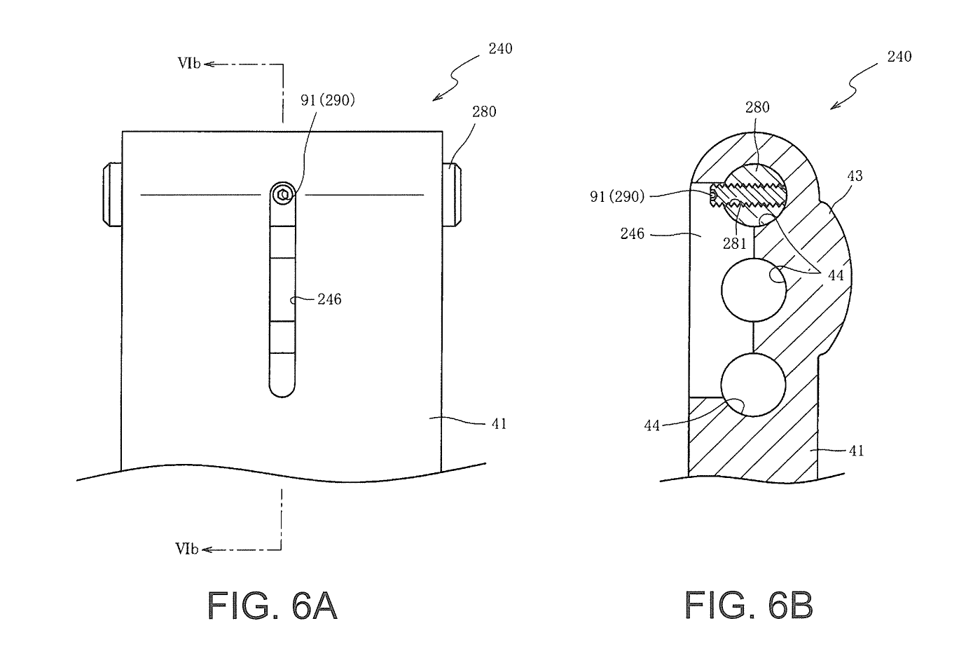

Next, a rotating member 240 of the second embodiment is described below with reference to FIG. 6A and FIG. 6B. In the first embodiment, the number of the fastening holes 46 is equal to the number of the engaging parts 44. In the second embodiment, only one insertion hole 246 is formed for a plurality of engaging parts 44. The same reference numerals are used to denote parts the same as the first embodiment. Thus, detailed descriptions thereof are not repeated hereinafter.

FIG. 6A is a partially enlarged front view of the rotating member 240 of the second embodiment. FIG. 6B is a partially enlarged cross-sectional view of the rotating member 240 taken along the line VIb-VIb of FIG. 6A. FIG. 6A and FIG. 6B illustrate a state where a weight 280 is installed in the upper engaging part 44 and is fixed by a set screw 290.

As shown in FIG. 6A and FIG. 6B, an insertion hole 246 of the rotating member 240 has a structure different from the structure of the fastening hole 46 of the first embodiment. With the exception of this point, the structure of the rotating member 240 is the same as the structure of the rotating member 40 of the first embodiment.

The insertion hole 246 is a hole provided for inserting the set screw 290. The insertion hole 246 penetrates through a portion of the main body part 41 between the front surface of the main body part 41 (the outer surface of the rotating member 240) and the engaging parts 44. More specifically, the insertion hole 246 is formed in the front surface of the main body part 41 and has a long hole shape that is elongated along the circumferential direction of the engaging parts 44 (i.e. the direction perpendicular to the axial direction of the engaging parts 44). Accordingly, the insertion hole 246 respectively communicates with the engaging parts 44 (three engaging parts 44 are formed in this embodiment).

The penetration direction of the insertion hole 246 is perpendicular to the axial direction of the engaging parts 44. In addition, the width of the insertion hole 246 (the length in the left-right direction of FIG. 6A) is equal to or slightly larger than the diameter of the set screw 290.

A fastening hole 281 is formed in the weight 280. With the exception of this point, the structure of the weight 280 is the same as the structure of the weight 80 of the first embodiment. The fastening hole 281 is a hole that passes through the axial center of the weight 280 perpendicularly. A female thread is formed on the inner peripheral surface of the fastening hole 281 for screwing the set screw 290, which will be described later. In addition, the total length of the set screw 290 is large. With the exception of this point, the structure of the set screw 290 is the same as the structure of the set screw 90 of the first embodiment.

The weight 280 is inserted into the engaging part 44 of the rotating member 240, and the set screw 290 inserted through the insertion hole 246 of the main body part 41 is screwed into the fastening hole 281 of the weight 280. Moreover, the inner peripheral surface of the engaging part 44 is pressed by the tip of the set screw 290. In this way, the outer peripheral surface of the weight 280 on the side opposite to the tip side of the set screw 290 is pressed against the inner peripheral surface of the engaging part 44 by reaction. As a result, the weight 280 can be fixed in the engaging part 44.

In this case, the insertion hole 246 of the rotating member 240 has a long hole shape that is elongated along the circumferential direction of the engaging parts 44 in the front view of the main body part 41, as described above. Therefore, according to the second embodiment, even if the fastening hole 281 of the weight 280 is displaced in the circumferential direction, the tip of the set screw 290 inserted in the insertion hole 246 can still be screwed into the fastening hole 281 of the weight 280 easily. Consequently, it is not required to rotate the weight 80 circumferentially in the engaging part 44 to align the insertion hole 246 and the fastening hole 281. In other words, the process of fixing the weight 280 in the engaging part 44 is simplified.

Here, the length (full length) of the set screw 290 in the axial direction is larger than the outer diameter of the weight 280. Thus, in a state that the set screw 290 is screwed into the fastening hole 281 of the weight 280 with the tip in contact with the inner peripheral surface of the engaging part 44 of the rotating member 240 (i.e. the state where the weight 280 is fixed in the engaging part 44), the rear end side (the side of the hexagonal hole 91) of the set screw 290 protrudes outside the outer peripheral surface of the weight 280. That is, the rear end side of the set screw 290 is in the insertion hole 246 of the rotating member 240.

Therefore, according to the second embodiment, even if the fastened set screw 290 is loose and causes the weight 280 to move in a direction (the left-right direction of FIG. 6A) out of the engaging part 44, the rear end side of the set screw 290 is locked to the inner peripheral surface of the insertion hole 246 and can restrict the movement of the weight 280. As a result, this configuration can prevent the weight 280 from inadvertently falling out of the engaging part 44.

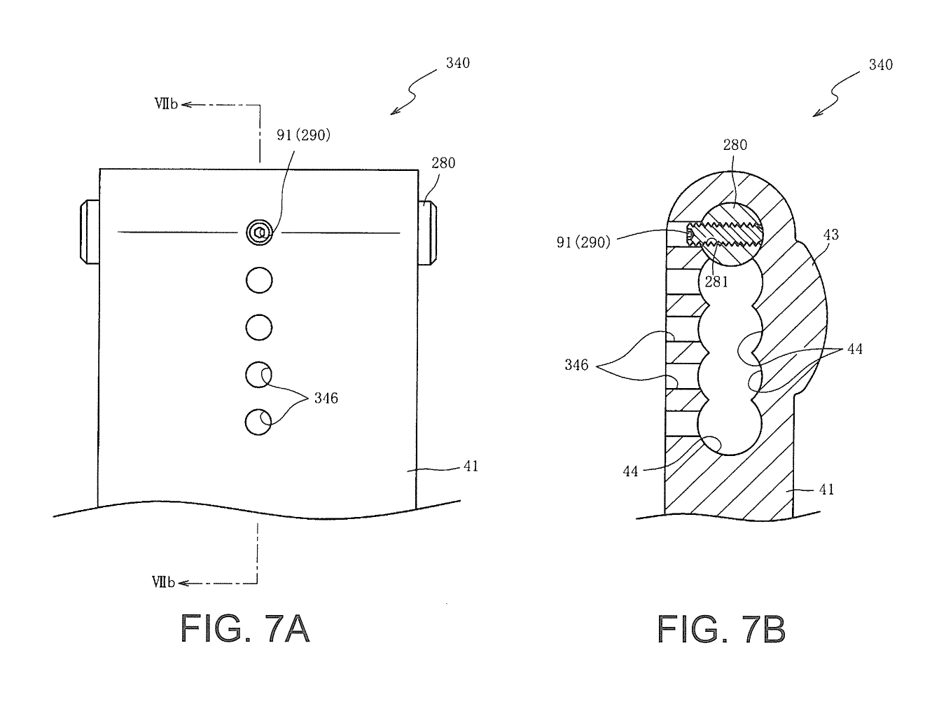

Next, a rotating member 340 of the third embodiment is described below with reference to FIG. 7A and FIG. 7B. In the first embodiment, the engaging parts 44 are spaced from each other. The engaging parts 44 of the third embodiment are respectively disposed to overlap the adjacent engaging parts 44. The same reference numerals are used to denote parts the same as those of the above embodiments. Thus, detailed descriptions thereof are not repeated hereinafter.

FIG. 7A is a partially enlarged front view of the rotating member 340 of the third embodiment. FIG. 7B is a partially enlarged cross-sectional view of the rotating member 340 taken along the line VIIb-VIIb of FIG. 7A. FIG. 7A and FIG. 7B illustrate a state where the weight 280 is installed in the uppermost engaging part 44 and the weight 280 is fixed by the set screw 290.

As shown in FIG. 7A and FIG. 7B, an insertion hole 346 of the rotating member 340 has a structure different from the structure of the fastening hole 46 of the first embodiment. However, the number of the engaging parts 44 and the number of the insertion holes 346 of the rotating member 340 are different from the number of the engaging parts 44 and the number of the fastening holes 46 of the first embodiment respectively. With the exception of these points, the structure of the rotating member 340 is the same as the structure of the rotating member 40 of the first embodiment.

The insertion hole 346 is a hole that has a circular cross section for inserting the set screw 290. The insertion hole 346 penetrates through a portion of the main body part 41 between the front surface of the main body part 41 (the outer surface of the rotating member 340) and the engaging parts 44. The insertion holes 346 are formed respectively corresponding to the engaging parts 44 (five engaging parts 44 are formed in this embodiment). In addition, an extension line of the axial center of the insertion hole 346 is perpendicular to the axial center of the engaging part 44.

Here, the weight 280 is inserted into the engaging part 44 of the rotating member 340, and the set screw 290 inserted through the insertion hole 346 of the main body part 41 is screwed into the fastening hole 281 of the weight 280. Moreover, the inner peripheral surface of the engaging part 44 is pressed by the tip of the set screw 290. In this way, the outer peripheral surface of the weight 280 on the side opposite to the tip side of the set screw 290 is pressed against the inner peripheral surface of the engaging part 44 by reaction. As a result, the weight 280 can be fixed in the engaging part 44.

In this case, according to the third embodiment, the engaging parts 44 are respectively disposed such that the internal spaces of the engaging parts 44 overlap each other in the main body part 41. Thus, the engaging parts 44 are close to each other and the distance therebetween can be shortened. In addition, more engaging parts 44 can be disposed in the limited space. As a result, with this structure that changes the installation position of the weight 280 to adjust the operational feeling of operating the pedal 20, a fine adjustment can be made. Moreover, the selection can be more flexible.

In this embodiment, the insertion holes 346 are formed independent of each other. The insertion holes 346 may be connected to form a long hole shape, as described in the second embodiment, for example. However, in the case that the engaging parts 44 are disposed with the internal spaces overlapping each other, like this embodiment, connecting the engaging parts 44 may result in low rigidity of the main body part 41. Therefore, in order to form the connection portion between the insertion holes 346 to ensure the rigidity of the main body part 41, it is preferred to form the insertion holes 346 independently.

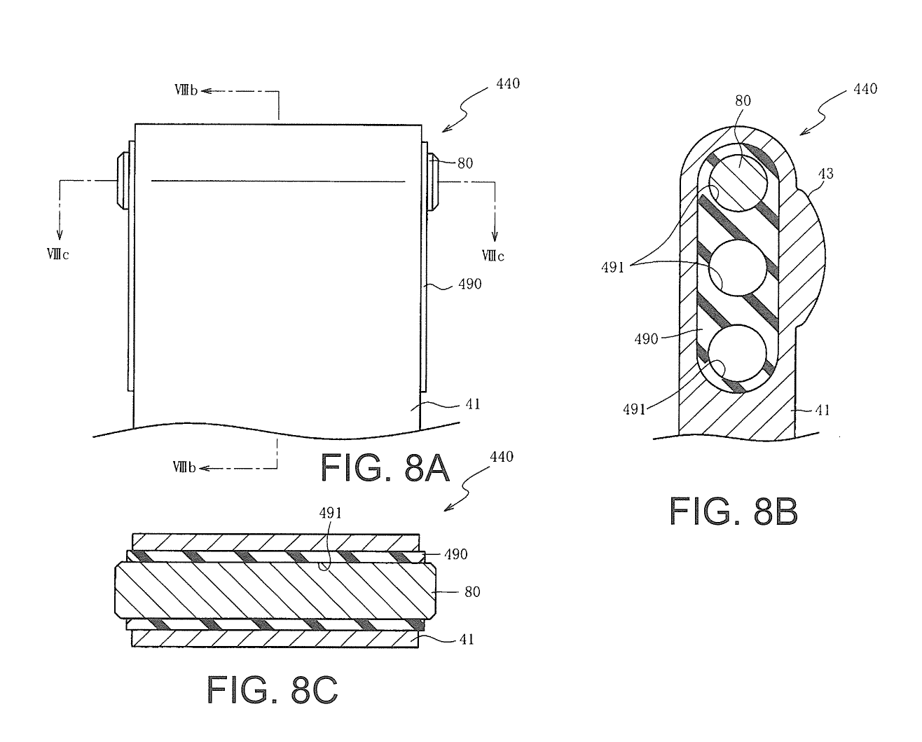

Then, a rotating member 440 of the fourth embodiment is described below with reference to FIG. 8A to FIG. 8C. In the first embodiment, the fastening force of the set screw 90 is used to fix (retain) the weight 80. The weight 80 of the fourth embodiment is fixed (retained) using an elastic force and a frictional force provided by an elastic base body 490 made of a rubbery elastic material. The same reference numerals are used to denote parts the same as those of the above embodiments. Thus, detailed descriptions thereof are not repeated hereinafter.

FIG. 8A is a partially enlarged front view of the rotating member 440 of the fourth embodiment. FIG. 8B is a partially enlarged cross-sectional view of the rotating member 440 taken along the line VIIIb-VIIIb of FIG. 8A. FIG. 8C is a partially enlarged cross-sectional view of the rotating member 440 taken along the line VIIIc-VIIIc of FIG. 8A. FIG. 8A to FIG. 8C illustrate a state where the weight 80 is installed in the upper engaging part 491.

In the rotating member 440, as shown in FIG. 8A to FIG. 8C, the fastening hole 46 of the first embodiment is omitted. Moreover, in the rotating member 440, engaging parts 491 are formed in the elastic base body 490 installed inside the main body part 41. With the exception of these points, the structure of the rotating member 440 is the same as the structure of the rotating member 40 of the first embodiment.

The elastic base body 490 is made of a rubbery elastic material. In addition, the elastic base body 490 has a rectangular shape in the front view, the width of which is slightly larger than the width of the main body part 41 (refer to FIG. 8A). Furthermore, the elastic base body 490 has an elliptical flat plate shape in the side view and is thinner than the thickness of the main body part 41. The elastic base body 490 is installed inside the main body part 41 with two side surfaces exposed.

In the fourth embodiment, the engaging parts 491 for engaging with the weight 80 are formed in the elastic base body 490. That is, the engaging parts 491 are through holes respectively having a circular cross section, which penetrate through the elastic base body 490 in the width direction. In addition, the engaging parts 491 are formed in multiple positions of the elastic base body 490. In this embodiment, the engaging parts 491 are formed in three positions, i.e. the upper section, the middle section, and the lower section. The inner diameter of the engaging part 491 is equal to or slightly smaller than the outer diameter of the weight 80.

Thus, according to the fourth embodiment, by installing (inserting) the weight 80 into the engaging part 491, the weight 80 can be fixed in the engaging part 491 by using the elastic resilience or frictional force of the elastic base body 490 made of a rubbery elastic material. Therefore, the process of fastening a screw when securing the weight 80 or the process of loosening the fastened screw when detaching the weight 80 is not required. In other words, the weight 80 can be attached or detached simply by inserting the weight 80 into the engaging part 491 or pushing (or pulling) the weight 80 out of the engaging part 491.

In particular, the same as the first embodiment, the engaging parts 491 respectively extend in parallel to the fourth axis AX4. Hence, when the weight 80 is under the centrifugal force that accompanies the rotation of the rotating member 440, the centrifugal force can be used to press the weight 80 against the engaging part 491. Thus, the engagement of the weight 80 with the engaging part 491 can be maintained stable.

A through hole is formed in the main body part 41. The through hole has a cross-sectional shape (elliptical shape) that is equal to or slightly smaller than the side surface shape (elliptical shape) of the elastic base body 490. The elastic base body 490 is pressed into the through hole and installed therein. That is to say, an adhesive for fixing the elastic base body 490 or time for the adhesive to dry is not required. As a result, the costs can be reduced. Further, if the elastic resilience of the elastic base body 490 decreases, the elastic base body 490 can be replaced easily. However, the elastic base body 490 may be fixed in the main body part 41 using an adhesive.

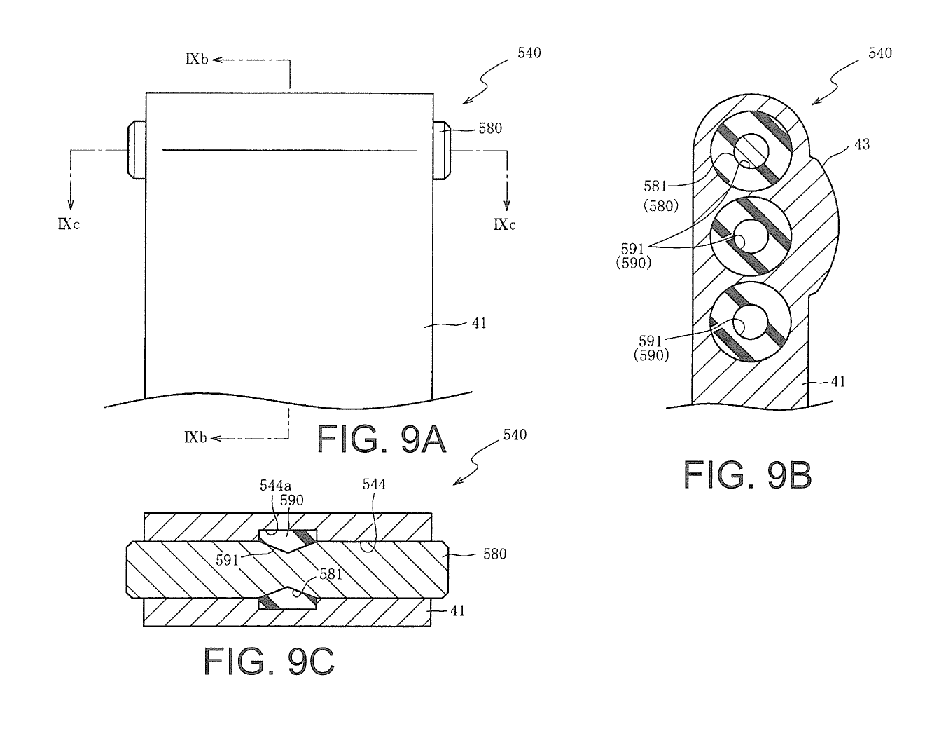

Then, a rotating member 540 of the fifth embodiment is described below with reference to FIG. 9A to FIG. 9C. In the first embodiment, the fastening force of the set screw 90 retains the weight 80 in the engaging part 44. In the fifth embodiment, the convex-concave fitting between the weight 580 and the elastic base body 590 retains the weight 580 in the engaging part 544. The same reference numerals are used to denote parts the same as those of the above embodiments. Thus, detailed descriptions thereof are not repeated hereinafter.

FIG. 9A is a partially enlarged front view of the rotating member 540 of the fifth embodiment. FIG. 9B is a partially enlarged cross-sectional view of the rotating member 540 taken along the line IXb-IXb of FIG. 9A. FIG. 9C is a partially enlarged cross-sectional view of the rotating member 540 taken along the line IXc-IXc of FIG. 9A. FIG. 9A to FIG. 9C illustrate a state where the weight 580 is disposed in the upper engaging part 544.

In the rotating member 540, as shown in FIG. 9A to FIG. 9C, the fastening hole 46 of the first embodiment is omitted. In addition, the weight 580 has a structure different from the structure of the weight 80 of the first embodiment. Moreover, an elastic base body 590 is disposed in the engaging part 544 of the rotating member 540. With the exception of these points, the structure of the rotating member 540 is the same as the structure of the rotating member 40 of the first embodiment.

A groove portion 544a is formed on the inner peripheral surface of the engaging part 544. The groove portion 544a has a U-shaped longitudinal cross section (the cross section through a plane including the axial center), and is an annular groove that is formed by continuing this shape in the circumferential direction. The elastic base body 590 is put into the groove portion 544a. The elastic base body 590 is made of a rubbery elastic material and has an annular shape when viewed in the axial direction. A convex 591 is formed on the inner peripheral surface of the elastic base body 590. The convex 591 is triangular in the longitudinal cross section and has an annular shape that continues in the circumferential direction. Moreover, the convex 591 protrudes in the axial direction with respect to the inner peripheral surface of the engaging part 544.

A concave 581 is formed on the weight 580. With the exception of this point, the structure of the weight 580 is the same as the structure of the weight 80 of the first embodiment. The concave 581 is triangular in the longitudinal cross section, and the size thereof corresponds to the convex 591 of the elastic base body 590 (equal sizes in this embodiment). The concave 581 has an annular shape that continues in the circumferential direction. In addition, the concave 581 is recessed on the outer peripheral surface of the weight 80 to form an annular reduced diameter portion.

Thus, according to the fifth embodiment, by installing (inserting) the weight 80 into the engaging part 544, the convex 591 of the elastic base body 590 and the concave 581 of the weight 580 are fitted to each other. The weight 580 can be fixed in the engaging part 544 through the convex-concave fitting. Therefore, the process of fastening a screw when securing the weight 580 or the process of loosening the fastened screw when detaching the weight 580 is not required. In other words, the weight 580 can be attached or detached simply by inserting the weight 580 into the engaging part 544 or pushing (or pulling) the weight 80 out of the engaging part 544.

Moreover, the convex 591 and the concave 581 are formed to be axially symmetrical simple shapes that continue in the circumferential direction in the same shape (triangular in the longitudinal cross section). For this reason, the elastic base body 590 and the weight 580 can be manufactured easily and the costs can be reduced. Further, it is not necessary to determine the circumferential position of the weight 580 with respect to the engaging part 544 (the elastic base body 590). Thus, the process of installing (inserting) the weight 580 into the engaging part 544 is simplified.

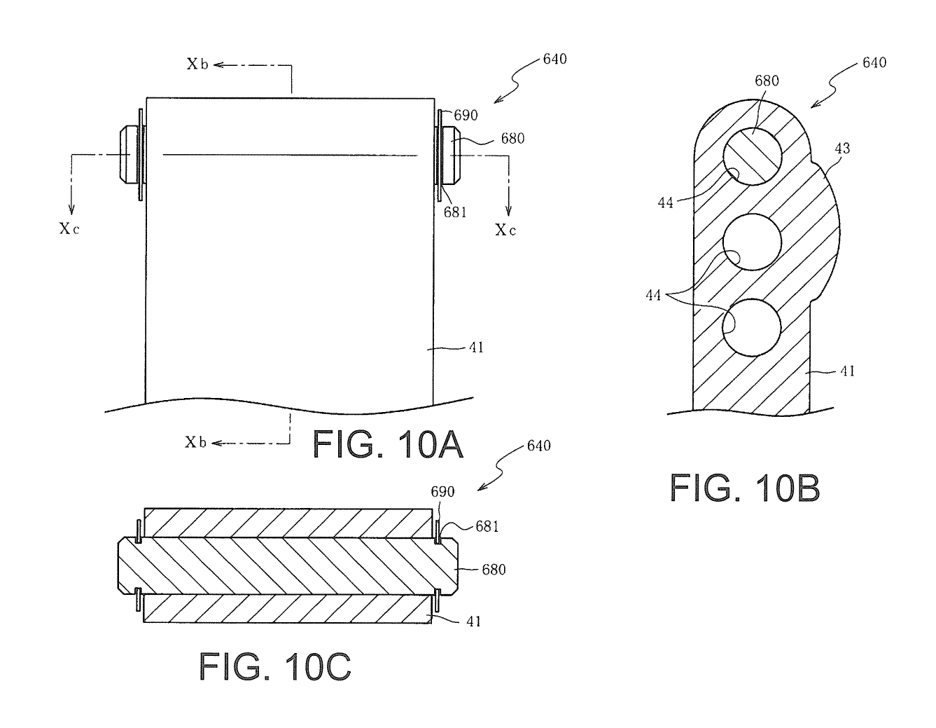

Next, a rotating member 640 of the sixth embodiment is described below with reference to FIG. 10A to FIG. 10C. In the first embodiment, the fastening force of the set screw 90 retains the weight 80. The weight 680 of the sixth embodiment includes a retaining ring 690 to serve as the retainer. The same reference numerals are used to denote parts the same as those of the above embodiments. Thus, detailed descriptions thereof are not repeated hereinafter.

FIG. 10A is a partially enlarged front view of the rotating member 640 of the sixth embodiment. FIG. 10B is a partially enlarged cross-sectional view of the rotating member 640 taken along the line Xb-Xb of FIG. 10A. FIG. 10C is a partially enlarged cross-sectional view of the rotating member 640 taken along the line Xc-Xc of FIG. 10A. FIG. 10A to FIG. 10C illustrate a state where the weight 680 is installed in the upper engaging part 44.

In the rotating member 640, as shown in FIG. 10A to FIG. 10C, the fastening hole 46 of the first embodiment is omitted. In addition, the weight 680 has a structure different from the structure of the weight 80 of the first embodiment. With the exception of these points, the structure of the rotating member 640 is the same as the structure of the rotating member 40 of the first embodiment.

Groove portions 681 are formed respectively on two end portions of the weight 680. In addition, the weight 680 includes the retaining ring 690 to be respectively fitted into each groove portion 681. With the exception of these points, the structure of the weight 680 is the same as the structure of the weight 80 of the first embodiment. The groove portion 681 has a U shape in the longitudinal cross section, which is recessed on the outer peripheral surface of the weight 680 as an annular groove that continues in the circumferential direction. Meanwhile, the retaining ring 690 is a so-called snap ring that is fitted into the groove portion 681 of the weight 680. The outer diameter of the retaining ring 690 is larger than the inner diameter of the engaging part 44. In this embodiment, an E ring is used as the retaining ring 690.

Thus, according to the sixth embodiment, the retaining rings 690 can be attached to or detached from the two ends of the weight 680. Therefore, the process of installing (inserting) the weight 680 into the engaging part 44 and the process of removing the weight 680 from the engaging part 44 can be simplified. In addition, this configuration can effectively prevent the weight 680 from falling out of the engaging part 44. In other words, by removing only the retaining ring 690 on one end side, the weight 680 can be easily inserted into the engaging part 44 from the one end side. Further, after the weight 680 is inserted, the retaining ring 690 is installed to the one end side. With the retaining rings 690 on the one end side and the other end side, the weight 680 can be effectively prevented from coming out of the engaging part 44 in either direction.

In this embodiment, the groove portions 681 are formed on two ends of the weight 680 for installing the retaining rings 690. Nevertheless, the groove portion 681 may be formed on only one end. In that case, a portion which has an outer diameter larger than the inner diameter of the engaging part 44 (e.g. a flange-shaped portion) is formed on the other end of the weight 680. The same as the sixth embodiment, this configuration also simplifies the process of attaching the weight 680 to or detaching the weight 680 from the engaging part 44 and can effectively retain the weight 680 in the engaging part 44.

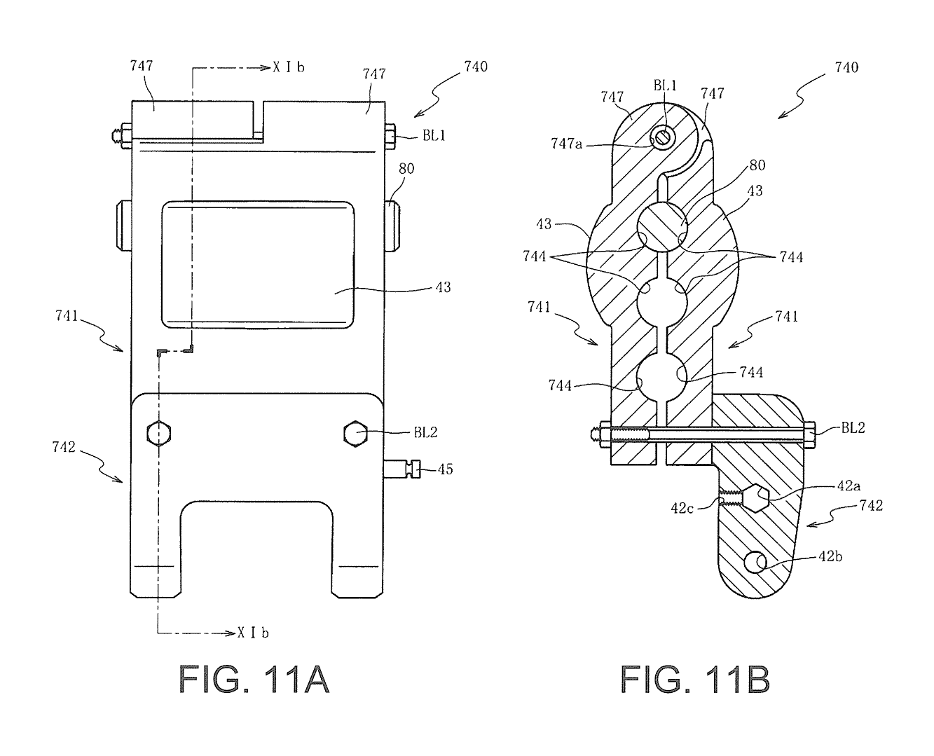

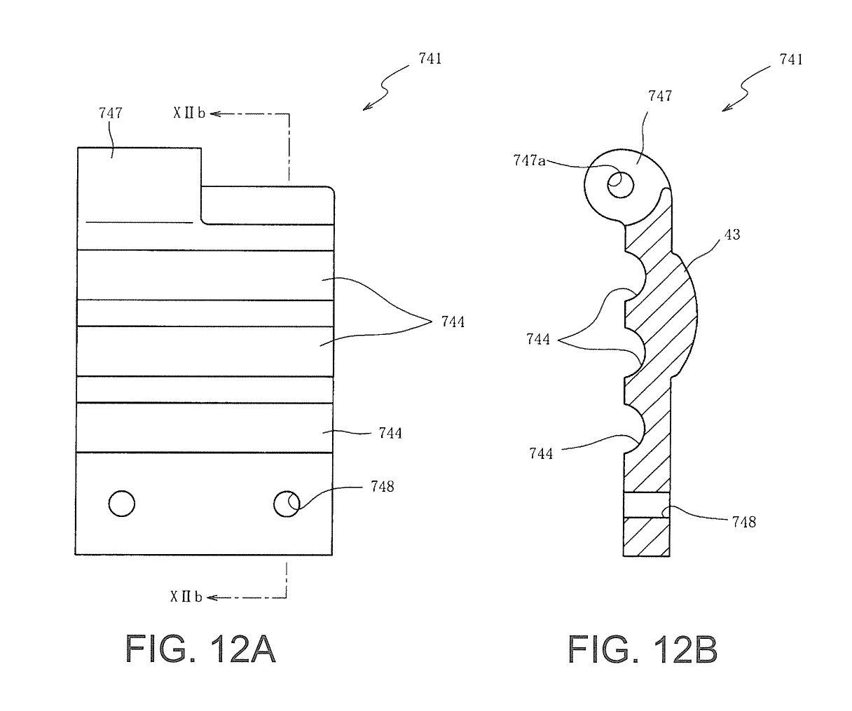

Hereinafter, a rotating member 740 of the seventh embodiment is described below with reference to FIG. 11A to FIG. 11B and FIG. 12A to FIG. 12B. In the first embodiment, the main body part 41 and the connecting legs 42 are formed integrally to constitute the rotating member 40. As to the rotating member 740 of the seventh embodiment, a pair of main body parts 741 and a connecting leg 742 are formed separately. The same reference numerals are used to denote parts the same as those of the above embodiments. Thus, detailed descriptions thereof are not repeated hereinafter.

FIG. 11A is a rear view of the rotating member 740 of the seventh embodiment. FIG. 11B is a cross-sectional view of the rotating member 740 taken along the line XIb-XIb of FIG. 11A. FIG. 11A to FIG. 11B illustrate a state where the weight 80 is installed in the upper engaging part 744. Moreover, the third axis AX3 and the fourth axis AX4 are omitted.

As shown in FIG. 11A and FIG. 11B, the rotating member 740 of the seventh embodiment mainly includes a pair of main body parts 741, the connecting leg 742, the striking parts 43, a plurality of engaging parts 744, and the spring connecting pin 45. The connecting leg 742 is fastened and secured on the pair of the main body parts 741. The striking parts 43 respectively protrude from the back surfaces of the main body parts 741. The engaging parts 744 are respectively formed in the pair of main body parts 741. The spring connecting pin 45 protrudes from the side surface of the connecting leg 742. The weight 80 is fixed between the opposing main body parts 741 (the engaging parts 744). Here, the main body part 741 is described with reference to FIG. 12A to FIG. 12B.

FIG. 12A is a front view of the main body part 741. FIG. 12B is a cross-sectional view of the main body part 741 taken along the line XIIb-XIIb of FIG. 12A. As shown in FIG. 12A and FIG. 12B, the main body part 741 has a predetermined thickness and has a flat plate shape that is rectangular and elongated in the front view. The main body part 741 mainly includes the engaging parts 744, a hinge part 747, and an insertion hole 748.

The engaging part 744 is a part provided for engaging the weight 80 between the engaging parts 744 of the opposing main body parts 741 (refer to FIG. 11A to FIG. 11B). The engaging parts 744 are recessed in multiple positions on the front surface of the main body part 741 to form grooves respectively having a semicircular cross section, which extend in the width direction of the main body part 741. In this embodiment, the engaging parts 744 are formed in three positions, i.e. the upper section, the middle section, and the lower section. In an assembly state of rotating member 740, the engaging parts 744 respectively extend in parallel to the third axis AX3 (the insertion hole 42a) and the fourth axis AX4 (the insertion hole 42b). In addition, the engaging parts 744 are equally spaced from each other.

The hinge part 747 is a part that serves as a connecting portion for connecting the opposing main body part 741. The hinge part 747 is formed on the upper end side of the main body part 741 and positioned in a range of one side (the left side of FIG. 12A) with respect to the center of the main body part 741 in the width direction. Furthermore, the hinge part 747 has a circular shape in the side view, which protrudes on the front surface side (the left side of FIG. 12B) of the main body part 741. An insertion hole 747a is formed to penetrate through the center of the circular shape of the hinge part 747. The insertion hole 747a is a hole having a circular cross section, into which a bolt BL1 (refer to FIG. 11A and FIG. 11B) is inserted. The axial center of the insertion hole 747a is disposed in a position that slightly protrudes with respect to the front surface of the main body part 741 (the left side of FIG. 12B). In addition, the insertion hole 747a is formed in parallel to the extension direction of the engaging part 744.

The insertion hole 748 is a hole having a circular cross section, into which a bolt BL2 (refer to FIG. 11A and FIG. 11B) is inserted for fastening and securing the connecting leg 742 on the pair of main body parts 741. A pair of the insertion holes 748 is formed to penetrate the lower end sides of the main body parts 741, and the insertion holes 748 are spaced in the width direction of the main body parts 741. The axial centers of the insertion holes 748 are perpendicular to the axial center of the insertion hole 747a in the hinge part 747. In other words, the bolt BL2 inserted in the insertion hole 748 is perpendicular to the bolt BL1 inserted in the insertion hole 747a (refer to FIG. 11A and FIG. 11B).

The following is explained with reference to FIG. 11A and FIG. 11B. The pair of main body parts 741 is used in a state that the front surfaces thereof face each other. Thereby, the hinge part 747 is put in the space on one side of the hinge part 747 of the other main body part 741, and the insertion holes 747a are arranged concentrically. Thus, by inserting the bolt BL1 into the insertion holes 747a and fastening the bolt BL1, the upper end sides (the hinge parts 747) are rotatably connected with the bolt BL1 as a rotation axis.

In this case, the two bolts BL2 that fasten and secure the connecting leg 742 on the lower end sides of the pair of main body parts 741 are perpendicular to the bolt BL1 that rotatably and pivotally supports the upper end sides (the hinge parts 747) of the main body parts 741. Hence, by fastening the bolts BL2, the pair of main body parts 741 can be rotated around the bolt BL1 to approach each other and to narrow the interval between the opposing engaging parts 744. Furthermore, by loosening the fastened bolts BL2, the pair of main body parts 741 can be rotated around the bolt BL1 to be separated from each other and to widen the interval between the opposing engaging parts 744.

Thus, according to the seventh embodiment, the weight 80 is inserted between the opposing engaging parts 744 of the pair of main body parts 741, and by fastening the bolts BL2, the weight 80 can be sandwiched between the opposing engaging parts 744. In other words, the weight 80 can be firmly fixed. Therefore, it is not necessary to dispose a means (e.g. set screw or retaining ring) for preventing the weight 80 from coming out of the engaging parts 744 during performance. As a result, the costs can be reduced.

In addition, the hinge part 747 is biased to one side of the main body part 741 in the width direction. Accordingly, the directionality of the main body part 741 can be eliminated. That is, the main body part 741 can be used both as the main body part 741 that constitutes the front surface side of the rotating member 740 and as the main body part 741 that constitutes the back surface side of the rotating member 740. Thus, the number of the parts of the rotating member 740 can be reduced to lower the costs.

Moreover, in the state that the pair of main body parts 741 is disposed with the front surfaces facing each other, the directionality of the front surface side and the back surface side of the assembly of the pair of main body parts 741 can also be eliminated. Thus, for the assembly of the pair of main body parts 741, it is not necessary to consider the direction of assembling the connecting leg 742. Hence, the connecting leg 742 can be assembled to either side (e.g. the right side or the left side of FIG. 11B) of the assembly of the pair of main body parts 741. As a result, the assembly process can be simplified and the costs can be reduced.

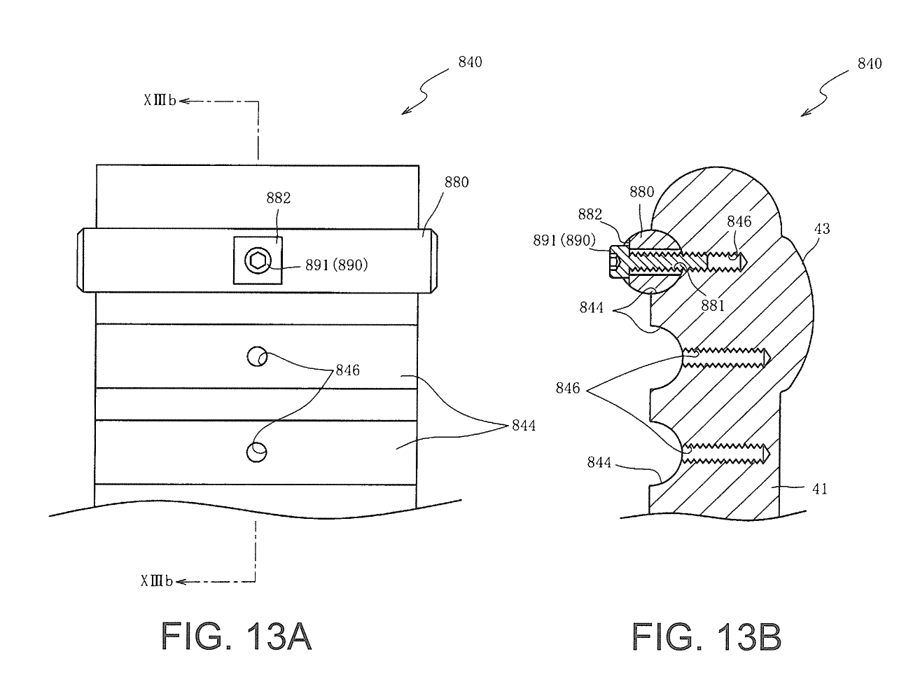

Next, a rotating member 840 of the eighth embodiment is described below with reference to FIG. 13A and FIG. 13B. In the first embodiment, the engaging parts 44 are through holes. The engaging parts 844 of the eighth embodiment are grooves. The same reference numerals are used to denote parts the same as those of the above embodiments. Thus, detailed descriptions thereof are not repeated hereinafter.

FIG. 13A is a partially enlarged front view of the rotating member 840 of the eighth embodiment. FIG. 13B is a partially enlarged cross-sectional view of the rotating member 840 taken along the line XIIIb-XIIIb of FIG. 13A. FIG. 13A to FIG. 13B illustrate a state where a weight 880 is installed in the upper engaging part 844.

As shown in FIG. 13A and FIG. 13B, engaging parts 844 and fastening holes 846 of the rotating member 840 have structures different from the structures of the engaging parts 44 and the fastening holes 46 of the first embodiment. With the exception of this point, the structure of the rotating member 840 is the same as the structure of the rotating member 40 of the first embodiment.

The engaging parts 844 are portions to be engaged with the weight 880. The engaging parts 844 are recessed in multiple positions on the front surface of the main body part 41 to form grooves respectively having a semicircular cross section, which extend in the width direction of the main body part 41. In this embodiment, the engaging parts 844 are formed in three positions, i.e. the upper section, the middle section, and the lower section. The engaging parts 844 respectively extend in parallel to the third axis AX3 and the fourth axis AX4 (refer to FIG. 2A, FIG. 2B, and FIG. 3). In addition, the engaging parts 844 are equally spaced from each other. The fastening hole 846 is a hole with a bottom, which is recessed on the inner peripheral surface of the engaging part 844. A female thread is formed on the inner peripheral surface of the fastening hole 846 for screwing a male thread of a set screw 890, which will be described later.

An insertion hole 881 and a receiving surface 882 are formed in the weight 880. With the exception of this point, the structure of the weight 880 is the same as the structure of the weight 80 of the first embodiment. The insertion hole 881 is a hole having a circular cross section, which passes through the axial center of the weight 880 perpendicularly. The insertion hole 881 has an inner diameter that allows the set screw 890 to be inserted thereinto. The set screw 890 will be described later. The receiving surface 882 is a portion which is formed on the outer peripheral surface of the weight 880 and has a flat surface perpendicular to the axial center of the insertion hole 881. A bearing surface of a head part 891 of the set screw 890, which will be described later, is disposed in contact with the receiving surface 882.

The set screw 890 includes a shaft part and the head part 891. The male thread is formed on the shaft part for screwing the set screw 290 to the female thread of the fastening hole 846. The head part 891 is disposed on the rear end of the shaft part and has a hexagonal hole. The outer diameter of the head part 891 is larger than the inner diameter of the insertion hole 881 of the weight 880. The shaft part (the male thread) of the set screw 890 inserted into the insertion hole 881 of the weight 880 is screwed into the fastening hole 846. In addition, the fastening force (axial force) is applied on the receiving surface 882 of the weight 880 through the bearing surface of the head part 891 of the set screw 890. As a result, the outer peripheral surface of the weight 880 is pressed against the inner peripheral surface of the engaging part 884, and the weight 880 can be fixed in the engaging part 844.

As described above, according to the eighth embodiment, the engaging parts 844 are grooves recessed on the outer surface (the front surface) of the rotating member 840 (the main body part 41). Thus, the rigidity of the rotating member 840 (the main body part 41) can be ensured in comparison with the case where the engaging parts are through holes that pass through the main body part in the width direction.

Further, the engaging parts 844 are grooves opened on the front surface side of the rotating member 840. Accordingly, like the case where the engaging parts are through holes, it is not necessary to remove or insert the weight 880 along the extension direction of the engaging part 884 when detaching or attaching the weight 880. For this reason, the space on the front surface side of the rotating member 840 (the main body part 41) can be utilized for attaching or detaching the weight 880.

In other words, the weight 880 can be attached or detached without considering the interference with the upright parts 13 of the base 10 (refer to FIG. 2B). Thus, the workability of attaching or detaching the weight 880 can be improved. Moreover, the design of the upright parts 13 can be more flexible. For example, in the state that the pedal 20 is at the initial position or the state that the pedal 20 is stepped, the weight 880 can still be attached to or detached from the engaging part 844 even if the engaging part 844 overlaps the upright part 13 in the side view. Accordingly, the shape of the upright parts 13 can be defined without regard to the positional relationship with respect to the engaging parts 844.

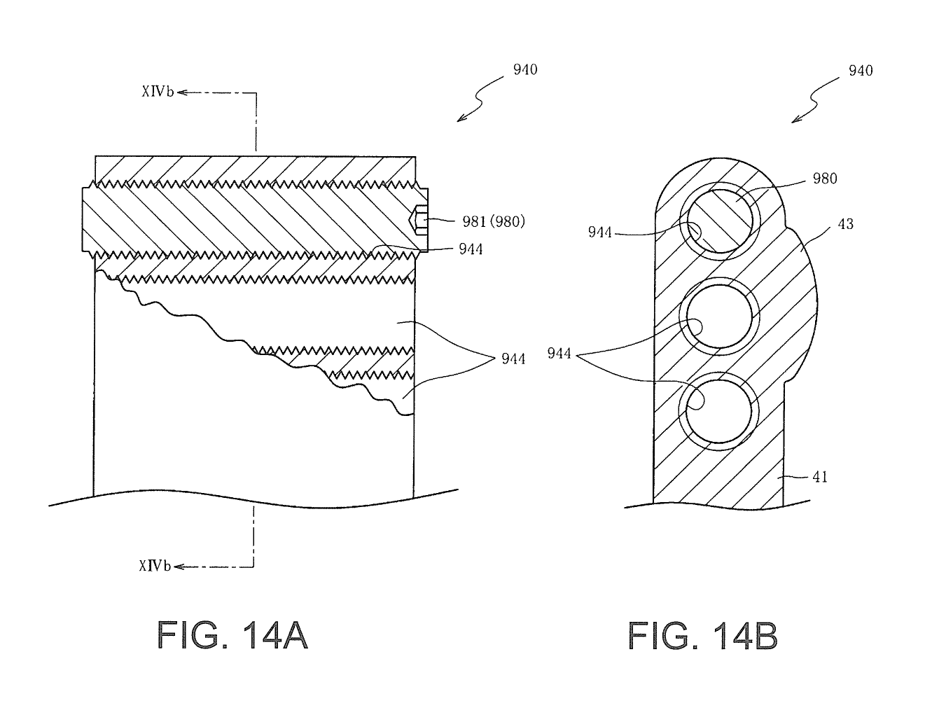

Next, a rotating member 940 of the ninth embodiment is described below with reference to FIG. 14A to FIG. 14B. In the first embodiment, the fastening force of the set screw 90 retains the weight 80 in the engaging part 44. In the ninth embodiment, an engaging part 944 and a weight 980 are formed such that the weight 980 can be screwed into the engaging part 944 and retained therein by the fastening force (frictional force). The same reference numerals are used to denote parts the same as those of the above embodiments. Thus, detailed descriptions thereof are not repeated hereinafter.

FIG. 14A is a partially enlarged front view and cross-sectional view of the rotating member 940 of the ninth embodiment. FIG. 14B is a partially enlarged cross-sectional view of the rotating member 940 taken along the line XIVb-XIVb of FIG. 14A. FIG. 14A and FIG. 14B illustrate a state where the weight 980 is installed in the upper engaging part 944. Moreover, in order to simplify the figure and make it easily comprehensible, the solid lines depicting crests and roots of the female thread on the inner surface of the engaging part 944 are omitted in FIG. 14A.

In the rotating member 940, as shown in FIG. 14A and FIG. 14B, the fastening hole 46 is omitted. Further, the engaging part 944 of the rotating member 940 has a structure different from the structure of the engaging part 44 of the first embodiment. With the exception of these points, the structure of the rotating member 940 is the same as the structure of the rotating member 40 of the first embodiment.

The female thread is formed on the inner peripheral surface of the engaging part 944 over the entire length thereof. A male thread is formed on the outer peripheral surface of the weight 980 over the entire length thereof for screwing the weight 980 to the female thread of the engaging part 944. A hexagonal hole 981 is formed on an end surface of the weight 980 in the axial direction. That is, the weight 980 is a full thread screw having the hexagonal hole 981 on one end surface in the axial direction.

Thus, according to the ninth embodiment, in the state where the female thread of the engaging part 944 and the male thread of the weight 980 are screwed to each other (i.e. the state where the weight 980 is fastened and secured in the engaging part 944), the weight 980 can be installed (inserted) in the engaging part 944. Therefore, the fastening force (frictional force) of the male thread and the female thread can prevent the weight 980 from coming out of the engaging part 944.

In this embodiment, the weight 980 is a full thread screw with no head part. Therefore, as shown in FIG. 14A and FIG. 14B, in the state where the weight 980 is properly installed in the engaging part 944, the weight is evenly balanced in the width direction of the rotating member 940. In other words, the rotating member 940 can be rotated stably. On the other hand, the weight 980 may include a head part. In that case, a bearing surface of the head part of the weight 980 can be disposed in contact with the side surface of the rotating member 940 (the main body part 41) to generate an axial force on the weight 980. Thus, loosening of the fastened male thread and female thread can be suppressed to effectively prevent the weight 980 from coming out of the engaging part 944.

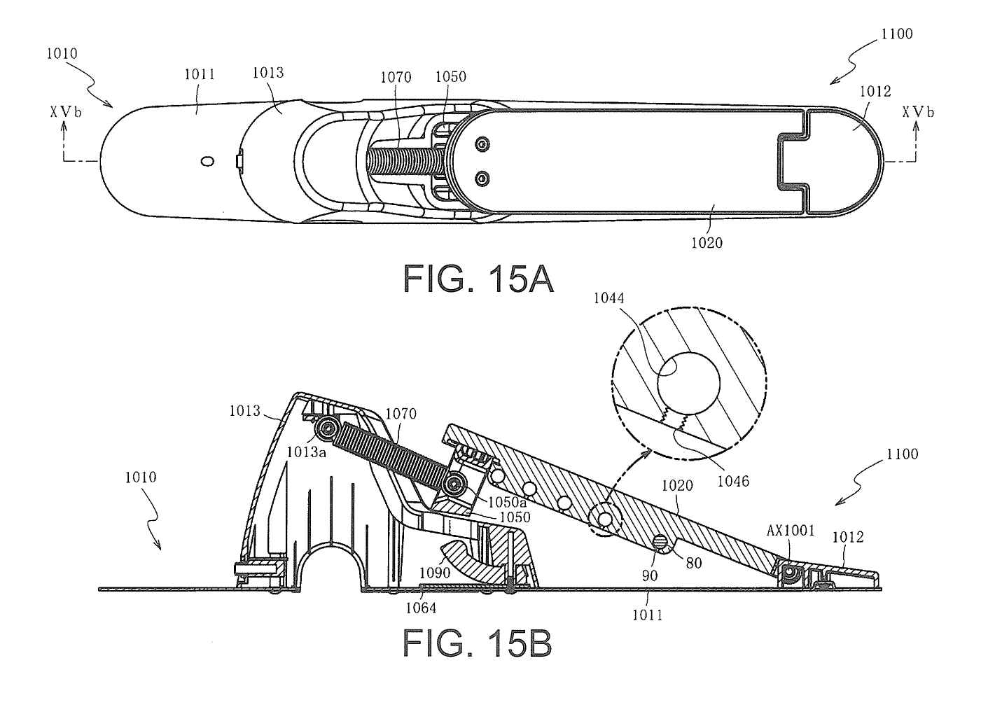

Hereinafter, a pedal device 1100 of the tenth embodiment is described with reference to FIG. 15A to FIG. 15B. In the first embodiment, the engaging parts 44 are formed in the rotating member 40 that is connected with the pedal 20 through the connecting member 30. In the tenth embodiment, engaging parts 1044 are formed in a pedal 1020. The same reference numerals are used to denote parts the same as those of the above embodiments. Thus, detailed descriptions thereof are not repeated hereinafter.

FIG. 15A is a top view of the pedal device 1100 of the tenth embodiment. FIG. 15B is a cross-sectional view of the pedal device 1100 taken along the line XVb-XVb of FIG. 15A. FIG. 15B illustrates a state where the weight 80 is installed in the lowermost (first) engaging part 1044.

As shown in FIG. 15A and FIG. 15B, the pedal device 1100 of the tenth embodiment mainly includes a base 1010, the pedal 1020, a weight member 1050, a biasing member 1070, and a sensor rubber 1090. The base 1010 is placed on the floor. The pedal 1020 is rotatably and pivotally supported by the base 1010. The weight member 1050 is disposed on a lower surface of the pedal 1020. The biasing member 1070 generates a biasing force for restoring the pedal 1020 to an initial position. The sensor rubber 1090 is positioned on a rotation track of the weight member 1050.

The base 1010 mainly includes a ground plate 1011, a pedal pivotal support part 1012, and a cover part 1013. The ground plate 1011 has a long plate shape and is placed on the floor (grounded). The pedal pivotal support part 1012 is disposed at one side of the ground plate 1011 in a longitudinal direction. The cover part 1013 is disposed at the other side of the ground plate 1011 in the longitudinal direction.

The pedal 1020 is disposed in a manner that a longitudinal direction of the pedal 1020 is consistent with the longitudinal direction of the ground plate 1011 of the base 1010. Furthermore, an end side of the pedal 1020 in the longitudinal direction is rotatably and pivotally supported by the pedal pivotal support part 1012 of the base 1010 through a first axis AX1001.

The biasing member 1070 is formed with a tension spring (coil spring). Moreover, an end of the biasing member 1070 is rotatably connected with a spring connecting part 1050a of the weight member 1050 in a state that the biasing member 1070 is pulled and elastically deforms. Further, the other end of the biasing member 1070 is rotatably connected with a spring connecting part 1013a of the cover part 1013.

Thus, in a state that the pedal 1020 is not stepped, the first axis AX1001, the spring connecting part 1050a, and the spring connecting part 1013a are on a substantially straight line due to the elastic resilience of the biasing member 1070. That is to say, the pedal 1020 is maintained at the initial position as shown in FIG. 15B. When the pedal 1020 is stepped, the biasing member 1070 is pulled and deformed and the biasing force is applied. Further, when the stepped pedal 1020 is released, the pedal 1020 returns to the initial position due to the elastic resilience of the biasing member 1070.

A sensor 1064 is disposed on an upper surface of the ground plate 1011, and the sensor 1064 is under the sensor rubber 1090. A base of the sensor rubber 1090 is fixed on the ground plate 1011. A tip of the sensor rubber 1090 is a free end. The sensor rubber 1090 is curved in an arc shape from the base fixed on the ground plate 1011 in the side view, and the tip of the sensor rubber 1090 is directed toward the weight member 1050. In addition, the sensor rubber 1090 is made of a rubbery elastic material.

When the pedal 1020 is stepped, the free end of the sensor rubber 1090 is pressed by the lower surface of the weight member 1050. In the meantime, the sensor rubber 1090 is deformed and a curvature thereof decreases. As a result, a contact area between the sensor rubber 1090 and the sensor 1064 increases.

That is, as the pedal 1020 is stepped down, the area of the sensor rubber 1090 that is in contact with the sensor 1064 increases. Therefore, a resistance value detected by the sensor 1064 decreases. The position of the stepped pedal 1020 can be detected based on a variation of the resistance value. In addition, the speed and pressure of stepping the pedal 1020 can be detected based on a variation speed of the resistance value. A musical sound conforming to the player's preference can be outputted from a sound source device (not shown) according to the detected detection signals.

The engaging parts 1044 for installing the weight 80 and fastening holes 1046 for screwing the set screw 90 are formed in the pedal 1020. By selecting an appropriate position (engaging part 1044) among the engaging parts 1044 to install the weight 80, the operational feeling (inertial force) of stepping on the pedal 1020 can be adjusted.

The engaging parts 1044 and the fastening holes 1046 are substantially the same as the engaging parts 44 and the fastening holes 46 of the first embodiment, except for the number of the engaging parts 1044 and the number of the fastening holes 1046. That is, a plurality of engaging parts 1044 (five engaging parts 1044 are formed in this embodiment) are formed along the longitudinal direction of the pedal 1020. In addition, the engaging parts 1044 are through holes respectively having a circular cross section, which pass through the pedal 1020 in the width direction. The engaging parts 1044 respectively extend in parallel to the first axis AX1001. The insertion hole 1046 respectively penetrates through a portion of the pedal 1020 between the lower surface (outer surface) of the pedal 1020 and the engaging part 1044. A female thread is formed on the inner peripheral surface of the fastening hole 1046 for screwing a male thread of the set screw 90.

The weight 80 is inserted into the engaging part 1044, and the set screw 90 is screwed into the fastening hole 1046 to press the outer peripheral surface of the weight 80 with the tip of the set screw 90. By doing so, the outer peripheral surface on the side opposite to the outer peripheral surface pressed by the tip of the set screw 90 is pressed against the inner peripheral surface of the engaging part 1044, so as to fix the weight 80 in the engaging part 1044.

In the tenth embodiment, distances between the engaging parts 1044 and the first axis AX1001 are defined as follows. The shortest one of the distances between the first axis AX1001 and the engaging parts 1044 (i.e. the distance between the first axis AX1001 and the rightmost engaging part 1044 of FIG. 15B) is defined as R. In that case, an n^{th} shortest one of distances between the first axis AX1001 and the engaging parts 1044 is defined as R multiplied by the square root of n.

More specifically, the distance between the first axis AX1001 and the first engaging part 1044 (the rightmost engaging part 1044 of FIG. 15B) is defined as “R”. The distance between the first axis AX1001 and the second engaging part 1044 is defined as “1.41*R”, which is a value obtained by multiplying R by the square root of 2. The distance between the first axis AX1001 and the third engaging part 1044 (the central engaging part 1044 of FIG. 15B) is defined as “1.73*R”, which is a value obtained by multiplying R by the square root of 3. The distance between the first axis AX1001 and the fourth engaging part 1044 is defined as “2*R”, which is a value obtained by multiplying R by the square root of 4. The distance between the first axis AX1001 and the fifth engaging part 1044 (the leftmost engaging part 1044 of FIG. 15B) is defined as “2.23*R”, which is a value obtained by multiplying R by the square root of 5.

Here, it is given that the weight 80, which has a mass in and a radius r, is positioned at a distance R with respect to the first axis AX1001. In that case, a moment of inertia J of the weight 80 around the first axis AX1001 is as follows: J=m*(r*r/2+R*R)=m*r*r/2+m*R*R. The first term on the right represents the moment of inertia when the weight 80 (a cylindrical body having the mass m and the radius r) rotates around the axial center thereof. The second term on the right hand side represents the moment of inertia when a mass point of the mass m rotates with the distance R as the radius.

The first term on the right hand side can be ignored if the radius r is sufficiently small compared with the distance R. Therefore, J=m*R*R. That is to say, the moment of inertia J of the weight 80 increases in proportion to the mass m of the weight 80 and in proportion to the square of the distance R. As described above, the installation position of the weight 80 (the distance between the engaging part 1044 and the first axis AX1001) is defined as the value obtained by multiplying R by the square root of n. Thus, the moment of inertia J can be increased proportionally as the installation position of the weight 80 is changed sequentially from the first engaging part 1044 to the fifth engaging part 1044.

As a result, the variation of the moment of inertia is in a proportional relationship with respect to the installation position of the weight 80, and this relationship can be grasped intuitively easily. Accordingly, the player can easily adjust the operational feeling of stepping on the pedal.

The above illustrates the present invention on the basis of the embodiments. However, the present invention is not limited to any of the embodiments. It can be easily inferred that various improvements or modifications may be made without departing from the spirit of the present invention.

The values given in the above embodiments are merely one of the examples, and it is certainly possible to adopt other values where appropriate.

The pedal devices 100 and 1100 may also be constructed by combining or replacing a part of or all of the structure of one of the above embodiments with a part of or all of the structure of another embodiment.

For example, in the second embodiment, the insertion hole 246 may be replaced by the insertion hole 346 of the third embodiment to make a new configuration. In other words, the configuration may include independent insertion holes 346 that respectively communicate with multiple engaging parts 44 (three engaging parts 44 are formed in the second embodiment).

For example, the retaining structure of the sixth embodiment that uses the retaining ring 690 to retain the weight 680 may be applied to the weight 80 of the fourth or the fifth embodiment. In other words, these two may be combined to make a new configuration.

For example, the fixing structure that uses the set screw 90 to fix the weight 80 in the tenth embodiment may be replaced by the fixing structure that uses the set screw 290 to fix the weight 280 in the second or the third embodiment. Alternatively, the fixing structure of the weight 80 in the tenth embodiment may be replaced by the fixing structures that use the elastic base bodies 490 and 590 to fix the weights 80 and 580 in the fourth and the fifth embodiments. Likewise, the fixing structure of the weight 80 in the tenth embodiment may be replaced by the fixing structure that fastens the weight 880 to the engaging part 844 having the semicircular cross section with the set screw 890 in the eighth embodiment. Alternatively, the fixing structure of the weight 80 in the tenth embodiment may be replaced by the fixing structure that screws the male thread of the weight 980 to the female thread of the engaging part 944 in the ninth embodiment.

For example, as described in the tenth embodiment, the technical concept of using the pedal 1020 as the object for installing the weight 80 may be applied to the pedal devices 100 of the first to the ninth embodiments. In that case, in the pedal device 100, the weight 80, etc. may be fixed to both the rotating members 40-940 and the pedal 20. Alternatively, the weight 80, etc. may be fixed only to the pedal 20.

For example, in the first to the ninth embodiments, the multiple engaging parts 44, 491, 544, 744, 844, and 944 are equally spaced. This arrangement method may be replaced by the arrangement method of the engaging parts 1044 of the tenth embodiment (the method that defines the distance between the n^{th} engaging part 1044 and the first axis AX1001 as R multiplied by the square root of n). The engaging parts 1044 of the tenth embodiment may also be equally spaced on the contrary.

In the above embodiments, the pedal devices 100 and 1100 include the sensors 64 and 1064 and are configured to serve as electronic musical instruments. However, the present invention is not limited thereto. The sensors 64 and 1064 may be omitted for using the pedal devices 100 and 1100 as practice pedal devices.

In the above embodiments, one or more than one of the weights 80, 280, 580, 680, 880, and 980 that have the same structure is used in the rotating members 40-940 or the pedal 1020. However, the present invention is not limited thereto. Weights 80, 280, 580, 680, 880, and 980 having different structures (e.g. different weights due to the difference of materials or full lengths) may be used in combination.

In the first to the ninth embodiments, the multiple engaging parts 44, 491, 544, 744, 844, and 944 are equally spaced. Moreover, in the tenth embodiment, the interval between the engaging parts 1044 is widened as the distance with respect to the first axis AX1001 decreases. Namely, the interval between two adjacent engaging parts 1044 that are disposed near the first axis AX1001 is larger than the interval between two adjacent engaging parts 1044 that are disposed far from the first axis AX1001. However, the present invention is not limited to the above. The interval between adjacent engaging parts may be narrowed as the distance with respect to the rotation axis decreases. In other words, the interval between adjacent engaging parts may be widened as the distance with respect to the rotation axis increases. By doing so, when the weight is installed in the engaging part near the rotation axis to lighten the operational feeling, fine adjustment can be made easily. On the other hand, when the weight is installed in the engaging part far away from the rotation axis to make the operational feeling heavier, the variation can be increased.

In the first to the ninth embodiments, the rotation direction of the rotating member 40, etc. around the fourth axis AX4 is the direction that the striking part 43 is lifted upward. However, the present invention is not limited thereto. The rotation direction of the rotating member 40, etc. may also be the direction that the striking part 43 is swung downward. Alternatively, the above may be combined to make a rotation configuration that the striking part 43 is swung downward after being lifted upward (or the other way around). In addition, the striking part 43 may be rotated horizontally. In any configuration, the player can get the operational feeling through rotation of the rotating member.

In the first or the tenth embodiment, the weight 80 has a circular cross section and the tip of the set screw 90 is in contact with the outer peripheral surface of the weight 80. However, the present invention is not limited thereto. A hole that has a bottom or a groove that extends in the circumferential direction may be recessed on the outer peripheral surface of the weight 80, and the tip of the set screw 90 may be disposed to be in contact with the bottom of the hole or the bottom of the groove. According to the above, even if the fastened set screw 90 is loose and causes displacement of the weight 80 in the direction out of the engaging part 44 and 1044, the tip portion of the set screw 90 is maintained in contact with the inner peripheral surface of the hole or the inner peripheral surface of the groove recessed on the outer peripheral surface of the weight 80. As a result, displacement of the weight 80 in the direction out of the engaging parts 44 and 1044 can be restricted.

In the third embodiment, the insertion holes 346 are circular holes respectively in the front view (cross section). However, the present invention is not limited thereto. A part of or all of the insertion holes 346 may also be elliptical holes in the front view (cross section), which are elongated in the circumferential direction of the engaging parts 44. In addition, a part of or all of these insertion holes 346 may be connected to communicate with each other. Thereby, efficiency of the process of fastening the set screw 290 to the fastening hole 281 through the insertion hole 346 can be improved. Alternatively, in the third embodiment, a part of or all of the insertion holes 346 may be elliptical holes in the front view (cross section), which are elongated in the axial direction of the engaging parts 44. In that way, efficiency of the process of fastening the set screw 290 to the fastening hole 281 through the insertion hole 346 can also be improved.

In the second or the third embodiment, the engaging parts 44 are through holes. However, the present invention is not limited thereto. The engaging part 44 may be a hole with a bottom. In that case, by disposing one end of the weight 280 in the axial direction to be in contact with the bottom of the hole, the position of the weight 280 with respect to the main body part 41 may be determined to make the positions of the insertion holes 246 and 346 and the fastening hole 281 consistent with each other. Accordingly, the rigidity of the main body part 41 can be improved. Moreover, efficiency of the process of fastening the set screw 290 to the fastening hole 281 through the insertion holes 246 and 346 can be improved.

In the fourth embodiment, the weight 80 has a cylindrical shape that has a constant outer diameter along the axial direction. However, the present invention is not limited thereto. A convex may protrude from the outer peripheral surface of the weight 80. Accordingly, by fitting the convex of the weight 80 to the inner peripheral surface of the engaging part 491, it is possible to more effectively prevent the weight 80 from coming out of the engaging part 491. In that case, a concave may be recessed on the inner peripheral surface of the engaging part 491 for fitting the convex of the weight 80. By fitting the convex of the weight 80 to the concave of the engaging part 491, it is possible to more effectively prevent the weight 80 from coming out of the engaging part 491.

In the fourth embodiment, the engaging parts 491 are formed in one elastic base body 490. However, the present invention is not limited thereto. The engaging parts 491 may be formed in independent elastic base bodies respectively. More specifically, a plurality of through holes are formed to penetrate through the main body part 41, and the elastic base bodies are respectively disposed in these through holes. In addition, one engaging part 491 is formed in each elastic base body.

In the eighth embodiment, one weight 880 is fixed in one engaging part 844. However, the present invention is not limited thereto. The shape of the weight 80 may be modified, so as to fix one weight 880 in two adjacent engaging parts 844.

In the ninth embodiment, the female thread and the male thread are respectively formed all over the engaging part 944 and the weight 980 in the axial direction. However, the present invention is not limited thereto. The female thread and the male thread may be partially formed on the engaging part 944 and the weight 980 in the axial direction respectively.

In addition to the pedal device for a musical instrument of the present invention, the following paragraphs further show various invention concepts included in the above embodiments.

Regarding the pedal device for a musical instrument as recited in the technical proposal 3 or 4, a pedal device A1 is characterized in that the rotating member includes a fastening hole which penetrates through a portion of the rotating member between the outer surface of the rotating member and the engaging part, and a female thread is formed on the inner peripheral surface of the fastening hole.

According to the pedal device A1, the rotating member includes the fastening hole that penetrates through a portion of the rotating member between the outer surface of the rotating member and the engaging part, and the female thread is formed on the inner peripheral surface of the fastening hole. A weight is inserted into the engaging part (through hole), and a male screw is screwed into the fastening hole to press the outer peripheral surface of the weight with the tip of the male screw. Thus, in addition to the effects of the pedal device of the technical proposal 3 or 4, the outer peripheral surface on the side opposite to the outer peripheral surface pressed by the tip of the male screw is pressed against the inner peripheral surface of the engaging part, so as to fix the weight in the engaging part. In this case, it is not necessary to determine the circumferential position of the weight with respect to the engaging part. Accordingly, the process of installing (inserting) the weight in the engaging part is simplified. In addition, it is not necessary to set the directionality of the weight in the circumferential direction. Therefore, the weight can be manufactured easily and the costs can be reduced.

Regarding the pedal device for a musical instrument as recited in the technical proposal 3 or 4, a pedal device A2 is characterized in including an elastic base body that is made of a rubbery elastic material and installed in the rotating member, and the engaging part is a through hole that penetrates through the elastic base body in a direction parallel to the rotation axis.

According to the pedal device A2, the elastic base body made of the rubbery elastic material and installed in the rotating member is disposed. Moreover, the through hole that penetrates through the elastic base body in the direction parallel to the rotation axis serves as the engaging part. Thus, in addition to the effects of the pedal device of the technical proposal 3 or 4, the weight can be fixed in the engaging part by using the elastic resilience or the frictional force of the rubbery elastic material. Accordingly, it is not required to perform the process of fastening the screw or loosening the fastened screw, and simply inserting the weight into the engaging part or pushing the weight out of the engaging part may suffice. In other words, the process of attaching the weight to or detaching the weight from the engaging part is simplified.

The cross-sectional shape of the engaging part in any of the pedal devices A1 and A2 can be set at will. For example, the cross-sectional shape of the engaging part may be circular, oval, or polygonal.

Regarding the pedal device for a musical instrument as recited in the technical proposal 3 or 4, a pedal device A3 is characterized in including a weight and a retaining ring. The weight has an annular groove portion on at least one end or both ends and the weight is inserted into the engaging part. The retaining ring is detachably installed in the groove portion of the weight and the retaining ring has an outer diameter larger than the inner diameter of the engaging part.

According to the pedal device A3, the retaining ring, which has the outer diameter larger than the inner diameter of the engaging part, is detachably installed on one end or both ends of the weight that is inserted into the engaging part. Thus, in addition to the effects of the pedal device of the technical proposal 3 or 4, the process of installing (inserting) the weight in the engaging part is simplified. Moreover, the weight can be effectively retained in the engaging part. In other words, by removing the retaining ring disposed on one end, the weight can be easily inserted into the engaging part through the one end. Then, by installing the retaining ring on the one end after inserting the weight, it is possible to effectively prevent the weight from coming out of the engaging part.

In the case that the groove portion is formed on only one end of the weight and the retaining ring can be installed in only one end of the weight, it is preferred to form the other end of the weight into a flange shape that has an outer diameter larger than the inner diameter of the engaging part. Likewise, the process of installing (inserting) the weight in the engaging part is also simplified. Moreover, the weight can be effectively retained in the engaging part.

Regarding the pedal device A2, a pedal device A4 is characterized in including a weight that is inserted into the engaging part. The weight has a convex that protrudes from the outer peripheral surface of the weight. Alternatively, the weight has a concave recessed on the outer peripheral surface of the weight and the engaging part has a convex that protrudes from the inner peripheral surface of the engaging part to be fitted to the concave of the weight.

According to the pedal device A4, the weight inserted into the engaging part is provided, and the convex protrudes from the outer peripheral surface of the weight. Alternatively, the concave is recessed on the outer peripheral surface of the weight, and the convex protrudes from the inner peripheral surface of the engaging part to be fitted to the concave of the weight. Thus, in addition to the effects of the pedal device A2, the former can effectively prevent the weight from coming out of the engaging part by fitting the convex of the weight to the inner peripheral surface of the engaging part. Furthermore, the latter can effectively prevent the weight from coming out of the engaging part by fitting the convex of the engaging part to the concave of the weight. In particular, the engaging part is formed in an elastic base body made of a rubbery elastic material. Accordingly, even if the convex is disposed as described above, the weight can still be inserted into or pushed out of the engaging part using the elasticity of the elastic base body. Therefore, the process of attaching the weight to or detaching the weight from the engaging part is simplified.

In the case that the convex protrudes from the outer peripheral surface of the weight, the concave may be formed on the inner peripheral surface of the engaging part to be fitted to the convex. In this way, the process of attaching the weight to or detaching the weight from the engaging part is simplified, and by fitting the convex of the weight to the concave of the engaging part, it is possible to effectively prevent the weight from coming out of the engaging part.

Regarding the pedal device for a musical instrument as recited in the technical proposal 3 or 4, a pedal device A5 is characterized in including a weight and an elastic embedded body. The weight has a concave that is recessed on the outer peripheral surface of the weight and the weight is inserted into the engaging part. The elastic embedded body is made of a rubbery elastic material and can be embedded in an annular groove portion formed on the inner peripheral surface of the engaging part. The elastic embedded body has a convex that protrudes from the inner peripheral surface of the engaging part to be fitted to the concave of the weight.

According to the pedal device A5, the weight inserted into the engaging part is provided, and the concave is recessed on the outer peripheral surface of the weight. In addition, the elastic embedded body, which has the convex to be fitted to the concave and is made of a rubbery elastic material, is disposed on the inner peripheral surface of the engaging part. Thus, in addition to the effects of the pedal device of the technical proposal 3 or 4, the weight can be fixed in the engaging part by using the fitting of the convex and the concave. In other words, it is not required to perform the process of fastening the screw or loosening the fastened screw, and simply inserting the weight into the engaging part or pushing the weight out of the engaging part may suffice. Accordingly, the process of installing (inserting) the weight in the engaging part is simplified. Further, through fitting the convex to the concave, it is possible to effectively prevent the weight from coming out of the engaging part.

Regarding the pedal device for a musical instrument as recited in the technical proposal 5, a pedal device A6 is characterized in that, among the insertion holes, at least two adjacent insertion holes are connected with each other. The connected insertion holes form a long hole shape that is elongated in the circumferential direction of the engaging part in the front view of the outer surface of the rotating member.

According to the pedal device A6, among the insertion holes, at least two adjacent insertion holes are connected with each other. Moreover, the connected insertion holes have the long hole shape that is elongated in the circumferential direction of the engaging part in the front view of the outer surface of the rotating member. Thus, in addition to the effects of the pedal device of the technical proposal 5, the length of the long hole shape can be increased. That is to say, a range for visibly checking the weight through the long hole shape and a permissible range in which the male screw can be moved in the insertion hole can both be increased. Therefore, even if the circumferential position of the weight (retaining hole) inserted in the engaging part is displaced with respect to the insertion hole, the male screw inserted in the insertion hole can be easily screwed or inserted into the retaining hole of the weight. As a result, the process of fixing the weight in the engaging part is simplified.

Further, all the insertion holes may be connected to form one long hole shape. In that case, the range for visibly checking the weight through the long hole shape and the permissible range in which the male screw can be moved in the insertion hole can both be further increased. Therefore, the process of fixing the weight in the engaging part can be further simplified.

Regarding the pedal device for a musical instrument as recited in the technical proposal 3 or 4, a pedal device A7 is characterized in including a weight that is inserted into the engaging part. A male thread is formed on at least a portion of the outer peripheral surface of the weight, and a female thread is formed on at least a portion of the inner peripheral surface of the engaging part for screwing the male thread of the weight.

According to the pedal device A7, the weight inserted into the engaging part is provided, and the male thread is formed on at least a portion of the outer peripheral surface of the weight. Moreover, the female thread is formed on at least a portion of the inner peripheral surface of the engaging part for screwing the male thread. Thus, in addition to the effects of the pedal device of the technical proposal 3 or 4, the weight can be installed (inserted) in the engaging part in a state where the male thread and the female thread are screwed to each other (i.e. a state where the weight is fastened and fixed in the engaging part). Thus, it is possible to prevent the weight from coming out of the engaging part.

Regarding the pedal device for a musical instrument as recited in any one of the technical proposals 3 to 6 or any one of the pedal devices A1 to A7, a pedal device A8 is characterized in that, among the engaging parts, at least two adjacent engaging parts are disposed in positions where inner spaces of the at least two adjacent engaging parts overlap each other.

According to the pedal device A8, at least two adjacent engaging parts are disposed in the positions where the inner spaces of the at least two adjacent engaging parts overlap each other. Therefore, in addition to the effects of the pedal device recited in any one of the technical proposals 3 to 6 or any one of the pedal devices A1 to A7, the engaging parts are arranged close to each other, and the interval therebetween can be shortened. Further, more engaging parts can be disposed in the limited space. As a result, fine adjustment can be made when adjusting the operational feeling of operating the pedal. Moreover, the selection can be more flexible.

Regarding the pedal device for a musical instrument as recited in any one of the technical proposals 1 to 6 or any one of the pedal devices A1 to A8, a pedal device A9 is characterized in that the interval between adjacent engaging parts is shortened as the distance with respect to the rotation axis decreases.

According to the pedal device A9, the interval between adjacent engaging parts is shortened as the distance with respect to the rotation axis decreases. In other words, the interval between adjacent engaging parts is widened as the distance with respect to the rotation axis increases. Therefore, in addition to the effects of the pedal device recited in any one of the technical proposals 1 to 6 or any one of the pedal devices A1 to A8, when the weight is installed in the engaging part close to the rotation axis to lighten the operational feeling, fine adjustment can be made easily. On the other hand, when the weight is installed in the engaging part far away from the rotation axis to make the operational feeling heavier, the variation can be increased.

Regarding the pedal device for a musical instrument as recited in any one of the technical proposals 1 to 6 or any one of the pedal devices A1 to A8, a pedal device A10 is characterized in that, if the shortest one of the distances between the rotation axis and the engaging parts is defined as R, a n^{th} shortest one of distances between the rotation axis and the engaging parts is defined as R multiplied by the square root of n.

According to the pedal device A10, if the shortest one of the distances between the rotation axis and the engaging parts is defined as R, a n^{th} shortest one of distances between the rotation axis and the engaging parts is defined as R multiplied by the square root of n. Therefore, in addition to the effects of the pedal device recited in any one of the technical proposals 1 to 6 or any one of the pedal devices A1 to A8, when the installation position (the engaging part) of the weight is changed sequentially, the moment of inertia is increased proportionally and the variation of the operational feeling of stepping on the pedal can be maintained constant.

What is claimed is:

1. A pedal device for a musical instrument, the pedal device comprising:
a pedal to be operated by a player;
a biasing member generating a biasing force for restoring the pedal to an initial position; and
a rotating member rotated around a rotation axis along with operation of the pedal, wherein
a plurality of engaging parts, which extend substantially in parallel to the rotation axis for engaging with a weight, are disposed in the rotating member and are respectively positioned at different distances with respect to the rotation axis.

2. The pedal device according to claim 1, comprising a striking part disposed on the rotating member, wherein at least a portion of the engaging parts are disposed in positions overlapping the striking part in a front view or disposed between the striking part and the rotation axis in the front view.

3. The pedal device according to claim 1, wherein the engaging parts are through holes that penetrate through the rotating member in parallel to the rotation axis.

4. The pedal device according to claim 3, comprising the weight that is inserted into the engaging part, wherein the engaging part is a through hole having a circular cross section, and the weight has a cylindrical shape having a circular cross section and having an outer diameter corresponding to an inner diameter of the engaging part.

5. The pedal device according to claim 3, comprising the weight that is inserted into the engaging part, wherein
the rotating member comprises an insertion hole that penetrates through a portion of the rotating member between an outer surface of the rotating member and the engaging part, and a male screw is inserted into the insertion hole for fixing the weight, and
the weight comprises a retaining hole that is recessed on or penetrates through the weight for screwing or inserting the male screw inserted in the insertion hole of the rotating member.

6. The pedal device according to claim 3, comprising the weight that is inserted into the engaging part and a screw member that is a full thread set screw for fixing the weight in the engaging part, wherein
the rotating member comprises an insertion hole that penetrates through a portion of the rotating member between an outer surface of the rotating member and the engaging part, and the screw member is inserted into the insertion hole,
the weight comprises a fastening hole that penetrates through the weight in a direction perpendicular to a longitudinal direction of the weight, and a female thread is formed on an inner peripheral surface of the fastening hole for screwing the screw member, and
a length of the screw member is set such that a rear end of the screw member is positioned in the insertion hole of the rotating member when a tip of the screw member screwed into the fastening hole of the weight is in contact with an inner peripheral surface of the engaging part of the rotating member.

7. The pedal device according to claim 1, comprising: a base placed on floor and rotatably and pivotally supporting one side of the pedal; a connecting member rotatably connecting an other side of the pedal on one side and rotatably connecting one side of the rotating member on the other side; a striking part disposed on the other side of the rotating member; and a struck part disposed on the base and positioned on a rotation track of the striking part, wherein the rotating member is rotatably and pivotally supported by the base through the rotation axis between the one side and the other side of the rotating member, and by stepping on the pedal, the rotating member is rotated around the rotation axis.

8. The pedal device according to claim 1, comprising a base that is placed on the floor, wherein by supporting the rotating member rotatably and pivotally around the rotation axis on the base, the rotating member also serves as the pedal.

9. The pedal device according to claim 1, comprising a sensor configured to detect an operational state of the pedal.

10. The pedal device according to claim 1, wherein the engaging parts are equally spaced.

11. The pedal device according to claim 1, wherein a shortest one of distances between the rotation axis and the engaging parts is defined as R, and a n^{th} shortest one of distances between the rotation axis and the engaging parts is defined as R multiplied by square root of n.

12. A pedal device for a musical instrument, the pedal device comprising:
a pedal to be operated by a player;
a biasing member generating a biasing force for restoring the pedal to an initial position; and
a base placed on floor and rotatably and pivotally supporting one side of the pedal, wherein
the pedal is rotated around a rotation axis of a pedal pivotal support part of the base along with operation of the player, and
a plurality of engaging parts, which extend substantially in parallel to the rotation axis for engaging with a weight, are disposed in the pedal and are respectively positioned at different distances with respect to the rotation axis.

13. The pedal device according to claim 12, further comprising a weight member disposed on a lower surface of the pedal, wherein one end of the biasing member is rotatably connected with the weight member and an other end of the biasing member is rotatably connected with a cover part of the base.

14. The pedal device according to claim 12, wherein the engaging parts are through holes that penetrate through the pedal in parallel to the rotation axis.

15. The pedal device according to claim 14, comprising the weight that is inserted into the engaging part, wherein the engaging part is a through hole having a circular cross section, and the weight has a cylindrical shape having a circular cross section and having an outer diameter corresponding to an inner diameter of the engaging part.

16. The pedal device according to claim 14, comprising the weight that is inserted into the engaging part, wherein
the pedal comprises an insertion hole that penetrates through a portion of the pedal between an outer surface of the pedal and the engaging part, and a male screw is inserted into the insertion hole for fixing the weight, and
the weight comprises a retaining hole that is recessed on or penetrates through the weight for screwing or inserting the male screw inserted in the insertion hole of the pedal.

17. The pedal device according to claim 14, comprising the weight that is inserted into the engaging part and a screw member that is a full thread set screw for fixing the weight in the engaging part, wherein
the pedal comprises an insertion hole that penetrates through a portion of the pedal between an outer surface of the pedal and the engaging part, and the screw member is inserted into the insertion hole,
the weight comprises a fastening hole that penetrates through the weight in a direction perpendicular to a longitudinal direction of the weight, and a female thread is formed on an inner peripheral surface of the fastening hole for screwing the screw member, and
a length of the screw member is set such that a rear end of the screw member is positioned in the insertion hole of the pedal when a tip of the screw member screwed into the fastening hole of the weight is in contact with an inner peripheral surface of the engaging part of the pedal.

18. The pedal device according to claim 12, comprising a sensor configured to detect an operational state of the pedal.

19. The pedal device according to claim 12, wherein the engaging parts are equally spaced.

20. The pedal device according to claim 12, wherein a shortest one of distances between the rotation axis and the engaging parts is defined as R, and a n^{th} shortest one of distances between the rotation axis and the engaging parts is defined as R multiplied by square root of n.
